(19) United States
(12) Patent Application Publication
(10) Pub. No.: US 2026/0334442 A1
(43) Pub. Date: Oct. 29, 2026

(54) METHOD FOR PRODUCING FISHING LINE, FISHING LINE, AND METHOD FOR EVALUATING FISHING LINE

(71) Applicant: DUEL CO., INC., Fukuoka-shi, Fukuoka (JP)

(72) Inventor: Eric Eun-Ha Choi, Fukuoka-shi, Fukuoka (JP)

(73) Assignee: DUEL CO., INC., Fukuoka-shi, Fukuoka (JP)

(21) Appl. No.: 19/485,342

(22) PCT Filed: Jun. 4, 2024
(86) PCT No.: PCT/JP2024/020367

§ 371 Date: Nov. 18, 2025

(30) Foreign Application Priority Data
Jun. 8, 2023 (WO) PCT/JP2023/021402

(51) Int. Cl. A01K 91/00

(52) U.S. Cl. CPC A01K 91/00

(57) ABSTRACT

There is provided a method for producing a fishing line by making a forming material containing a colorant and a resin component into yarn, wherein a spectral transmittance of the fishing line at a wavelength of 425 nm to 575 nm is within a range of 13% to 40%, and a spectral transmittance L0Z of the fishing line at a wavelength of 525 nm satisfies 25.1X^{-0.23}<L0Z<12.9X^{-0.38} where X represents a diameter (mm) of the fishing line.

### TECHNICAL FIELD

The present invention relates to a method for producing a fishing line for fishing, and the like.

### BACKGROUND ART

Fish to be fished (hereinafter, referred to as target fish) can be roughly classified into saltwater fish and freshwater fish, and in particular, saltwater fish are often very wary. It is a great attraction for anglers to catch wary fish. In order to increase the catch, it is important that the fishing line is not recognized by the fish. Therefore, it is desired to use a fishing line as thin as possible to avoid alerting the fish, but an extremely thin fishing line has a high probability of being broken when a large fish is caught on the fish hook. Therefore, a fishing line that is hardly recognized by fish is desired.

Patent Document 1 discloses a colored leader for saltwater fishing having a maximum value of absorption within a wavelength range of 500 to 600 nm in a visible light absorption spectrum. Patent Document 1 describes that this leader (fishing line) is hardly recognized by black sea bream and red sea bream, and can be suitably used for these fish species.

### PRIOR ART DOCUMENT

### Patent Document

Patent Document 1: Japanese Patent Laid-open Publication No. 2003-52287

### SUMMARY OF THE INVENTION

However, the fishing line of Patent Document 1 may be effective when the target fish is black sea bream or red sea bream, but cannot be said to be effective for other target fish.

### Problems to be Solved by the Invention

An object of the present invention is to provide a method for producing a fishing line in which a good catch can be expected for various fish species.

### Solutions to the Problems

In one aspect, a method for producing a fishing line is provided.

In the method for producing a fishing line, the fishing line is produced by making a forming material containing a colorant and a resin component into yarn, wherein a spectral transmittance of the fishing line at a wavelength of 425 nm to 575 nm is within a range of 13% to 40%, and a spectral transmittance L0Z of the fishing line at a wavelength of 525 nm satisfies 25.1X^{-0.23}<L0Z<12.9X^{-0.38} where X represents a diameter (mm) of the fishing line. Preferably, the resin component contains polyvinylidene fluoride.

In another aspect, a fishing line is provided.

The fishing line includes a colorant and a resin component, wherein a spectral transmittance of the fishing line at a wavelength of 425 nm to 575 nm is within a range of 13% to 40%, and a spectral transmittance L0Z of the fishing line at a wavelength of 525 nm satisfies a relationship of 25.1X^{-0.23}<L0Z<12.9X^{-0.38} where X represents a diameter (mm) of the fishing line.

In another aspect, a method for evaluating a fishing line is provided.

A method for evaluating a fishing line includes measuring a spectral transmittance and a diameter of the fishing line and confirming that a spectral transmittance of the fishing line at a wavelength of 425 nm to 575 nm satisfies 13% to 40%, and a spectral transmittance L0Z of the fishing line at a wavelength of 525 nm satisfies a relationship of 25.1X^{-0.23}<L0Z<12.9X^{-0.38} where X represents a diameter (mm) of the fishing line.

### Effects of the Invention

By using the fishing line of the present invention, a good catch can be achieved for various fish species, in particular for various saltwater fish.

### BRIEF DESCRIPTION OF THE DRAWINGS

FIG. 1 is a front view of a fishing line with both ends omitted.

FIG. 2 is an enlarged cross-sectional view taken along a line II-II in FIG. 1.

FIG. 3 is a reference graph showing the photosensitivity of saltwater fish for each wavelength.

FIG. 4 is a view for explaining a method for measuring the reflectance of a fishing line, and is a front view illustrating a state in which a fishing line is wound around a glass plate.

FIG. 5 is a view for explaining a method for measuring the reflectance of a fishing line, and is a reference view illustrating a state in which a glass plate around which a fishing line is wound is disposed on an integrating sphere.

FIG. 6 is graphs of spectral reflectance L1, spectral reflectance L2, and spectral transmittance L0 of a fishing line in Example 1.

FIG. 7 is graphs of spectral reflectance L1, spectral reflectance L2, and spectral transmittance L0 of a fishing line in Example 4.

FIG. 8 is graphs of spectral reflectance L2 and spectral transmittance L0 of fishing lines in Examples 2 and 3.

FIG. 9 is graphs of spectral reflectance L2 and spectral transmittance L0 of fishing lines in Examples 5 to 8.

FIG. 10 is graphs of spectral reflectance L2 and spectral transmittance L0 of fishing lines in Examples 9 to 12.

FIG. 11 is graphs of spectral reflectance L2 and spectral transmittance L0 of fishing lines in Examples 13 to 16.

FIG. 12 is graphs of spectral reflectance L2 and spectral transmittance L0 of fishing lines in Examples 17 to 20.

FIG. 13 is graphs of spectral reflectance L2 and spectral transmittance L0 of fishing lines in Examples 21 to 24.

FIG. 14 is graphs of spectral transmittance L0 of fishing lines in Comparative Examples 5 to 10.

FIG. 15 is graphs of spectral transmittance L0 of fishing lines in Comparative Examples 11 to 16.

FIG. 16 is a graph showing the relationship between the yarn diameter and the spectral transmittance at a wavelength of 525 nm of the fishing lines in Examples and Comparative Examples.

FIG. 17 is a graph showing boundary lines between Examples and Comparative Examples, in the graph of FIG. 16.

### EMBODIMENTS OF THE INVENTION

In the present specification, a numerical range represented by “lower limit GG to upper limit HH” means the lower limit GG or more and the upper limit HH or less. When a plurality of the numerical ranges is described separately, an arbitrary lower limit and an arbitrary upper limit can be selected to set “an arbitrary lower limit to an arbitrary upper limit”.

### [Configuration of Fishing Line]

From the viewpoint of the yarn configuration, the fishing line of the present invention may be a monofilament, a so-called braided yarn obtained by braiding a multifilament including a plurality of thin monofilaments, or a fused yarn in which a plurality of thin monofilaments are fused to form one yarn. A monofilament is preferable from the viewpoint of excellent durability.

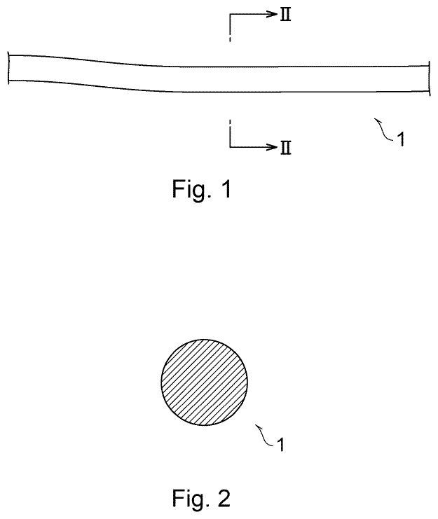

Referring to FIGS. 1 and 2, a fishing line 1 of the present invention has an elongated yarn shape, and is usually substantially circular in a cross-sectional view from the viewpoint of a cross-sectional shape. From the viewpoint of size, the diameter of the fishing line 1 is, for example, 0.1 mm to 2.5 mm.

From the viewpoint of composition, the fishing line contains a resin component and a colorant, and may contain any appropriate additive as necessary. Examples of the additive include a light resistance agent, an ultraviolet absorber, an antioxidant, a crystallization inhibitor, and a plasticizer.

The resin component is not particularly limited, and examples thereof include vinylidene-based resins such as polyvinylidene fluoride, olefin-based resins such as high molecular weight polyethylene, polyamide-based resins, and polyester-based resins. A fishing line containing a vinylidene-based resin such as polyvinylidene fluoride is preferable because the vinylidene-based resin is excellent in high strength, abrasion resistance, weather resistance, and low water absorption, and has a refractive index of light close to that of water.

The colorant is not particularly limited as long as it satisfies the spectral transmittance in the above wavelength range. Typical examples of the colorant include pigments such as inorganic pigments and organic pigments, and dyes. These can be used singly or in combination of two or more kinds thereof.

Examples of the inorganic pigment include iron oxide, red iron oxide, alkali blue, lithol red, carmine 6B, disazo yellow, phthalocyanine blue, quinacridone red, and isoindoline yellow. Examples of the organic pigment include anthraquinone-based, azo-based, and perylene-based pigments. Examples of the dye include auramine, fuchsin, methylene blue, malachite green, crystal violet, and cationic dye.

It is preferable to use a pigment as the colorant because it can form a fishing line having an excellent dyeing rate and excellent color fastness. Furthermore, among the pigments, an organic pigment is more preferably used because yarn breakage hardly occurs in the production of a fishing line.

The content of the colorant is appropriately set. In the relationship between the content of the colorant and the diameter of the fishing line, the fishing line in which the content Y0 of the colorant satisfies the following Formula (1) is preferable. In particular, a fishing line containing an organic pigment as a colorant and a polyvinylidene fluoride-based resin as a resin component preferably satisfies the relationship of the following Formula (1). The fishing line satisfying the relationship of the following Formula (1) improves a catch for many fish species among saltwater fish and freshwater fish. Specifically, according to the study of the present inventors, when the content Y0 of the colorant is Y2 or less, there is a possibility that only the same level of catch as that of an uncolored fishing line can be expected. When the content Y0 of the colorant is Y1 or more, the biting frequency of fish (both saltwater fish and freshwater fish) may be deteriorated as compared with an uncolored fishing line. Regarding the catch, it is estimated that there is an interaction between the above-described spectral transmittance range and the content of the colorant.

Y2<Y0<Y1 Formula (1):

Y1=58.6X^{-0.65} Formula (2):

Y2=8.9X^{-1.46} Formula (3):

where X represents the diameter (mm) of the fishing line, Y0 represents the content (ppm) of the colorant, Y1 represents the upper limit (ppm) of the content of the colorant, and Y2 represents the lower limit (ppm) of the content of the colorant.

Formula (1) expresses the relationship between the yarn diameter and the content of the colorant in the fishing line satisfying the following Formula (4). Specifically, Formula (2) can be calculated by applying the least squares method and performing power approximation using, as data, the content of the colorant satisfying the upper limit of Formula (4) for each yarn diameter of the fishing line on a graph taking the content of the colorant on the vertical axis and the yarn diameter on the horizontal axis. Formula (3) can be calculated by applying the least squares method and performing power approximation using, as data, the content of the colorant satisfying the lower limit of Formula (4) for each yarn diameter of the fishing line on a graph taking the content of the colorant on the vertical axis and the yarn diameter on the horizontal axis.

In the optical characteristics of the fishing line, the spectral transmittance at a wavelength of 425 nm to 575 nm is 13% to 40%, and the spectral transmittance L0Z at a wavelength of 525 nm satisfies the relationship of 25.1X^{-0.23}<L0Z<12.9X^{-0.38} where X represents the diameter (mm) of the fishing line.

25.1X^{-0.23}<L0Z<12.9X^{-0.38} Formula (4):

In Formula (4), L0Z represents the spectral transmittance of the fishing line at a wavelength of 525 nm, and X represents the diameter (mm) of the fishing line.

The fishing line satisfying the relationship of Formula (4) can be expected to have a good catch for various fish species, particularly various saltwater fish.

The spectral transmittance at a wavelength of 425 nm to 575 nm of 13% to 40% means that the spectral transmittance in the entire wavelength range of 425 nm to 575 nm is in the range of 13% to 40%. The fishing line preferably has a spectral transmittance of 14% to 38%, more preferably 17% to 37% at a wavelength of 425 nm to 575 nm.

In the fishing line, the difference between the maximum value of the spectral transmittance at a wavelength of 425 nm to 575 nm and the minimum value of the spectral transmittance at a wavelength of 425 nm to 575 nm (maximum value−minimum value) is preferably 13% or less, and the difference (maximum value−minimum value) is more preferably 6% to 12%, and still more preferably 8% to 11%.

The fishing line preferably has a spectral transmittance of, for example, 18% or more, more preferably 20% or more at a wavelength of 575 nm to 700 nm (however, since 575 nm overlaps in relation to the wavelength of 425 nm to 575 nm, here, it means a wavelength of more than 575 nm to 700 nm).

The spectral transmittance of the fishing line can be measured by [Method for measuring spectral transmittance L0] described in the following Examples. That is, the spectral transmittance L0 of the fishing line can be specified by measuring the sum (spectral reflectance L1) of the reflectance of the light reflected by the fishing line and the reflectance of the light transmitted through and reflected by the fishing line, measuring the reflectance (spectral reflectance L2) of the light reflected by the fishing line, and subtracting the spectral reflectance L2 from the spectral reflectance L1.

The fishing line has a spectral reflectance of, for example, 26% or less at a wavelength of 425 nm to 700 nm, preferably 21% or less at a wavelength of 425 nm to 700 nm, and more preferably 12% to 21% at a wavelength of 425 nm to 700 nm.

In the fishing line, the difference between the maximum value of the spectral reflectance at a wavelength of 425 nm to 700 nm and the minimum value of the spectral reflectance at a wavelength of 425 nm to 700 nm is (maximum value−minimum value), for example, 9% or less, and the difference (maximum value−minimum value) is preferably 4% to 8%.

Furthermore, the fishing line of the present invention has a spectral reflectance of, for example, 20% or less at a wavelength of 425 nm to 575 nm, and preferably 10% to 20% at a wavelength of 425 nm to 575 nm.

The spectral reflectance of the fishing line refers to a reflectance of only light that hits the fishing line and is reflected. The spectral reflectance L2 of the fishing line can be measured by <Measurement of spectral reflectance L2> described in the following Examples.

By using the fishing line of the present invention, a relatively large number of fish species can be caught. This is also apparent from [Actual fishing test] of the following Examples. The reason why a good catch can be expected is not clear, but the present inventors estimate as follows.

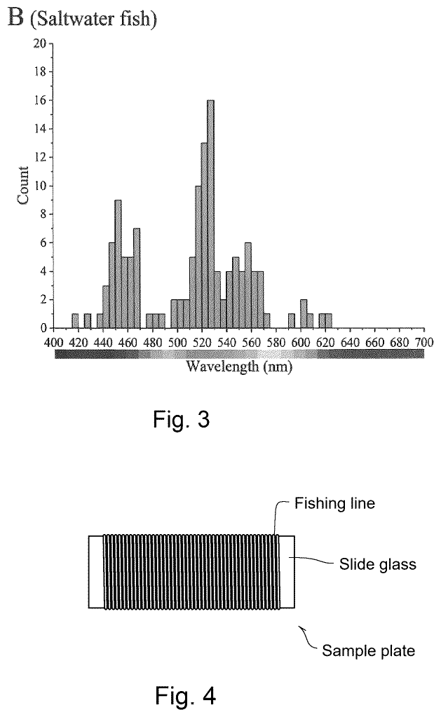

Wavelength sensitivity data of 54 kinds of saltwater fish are shown in a relatively recent research paper “Fish habitat environment and color vision” (received on Jun. 10, 2021, Kyoichi TAKAHASHI, ed., Hiroshima Shudo University Research Paper, p. 31 to 76). A bar graph of the wavelength sensitivity data of the paper is cited in FIG. 3. Here, the research paper states that, among the 54 kinds of saltwater fish, only 5 kinds of saltwater fish have photosensitivity to a red region, and most of saltwater fish have photosensitivity to a wavelength region of 420 nm to 480 nm (blue region) and 500 nm to 580 nm (green region). In particular, it is found that saltwater fish are highly sensitive to light at 520 nm.

When light of various colors (wavelengths) hits the fishing line, light of one color passes through the fishing line, light of another color is absorbed into the fishing line, and a part of the light is reflected. The fish visually perceives light in a state in which light transmitted through the fishing line and light reflected by the fishing line are mixed, and recognizes light of the captured color as the color and brightness of the fishing line.

As the target fish for fishing, there are fish that can identify color and fish that cannot identify color. Examples of the fish that can identify color include sea bass, right-eyed flounder, largescale blackfish, left-eyed flounder, and sweetfish. Examples of the fish that cannot identify color include cod, conger eel, red bream, and lizardfish. In addition, fish living in the deep sea to which light does not reach often cannot identify color. Note that a mollusk such as common octopus, bigfin reef squid, or cuttlefish cannot be called a fish in a strict sense, but in the present specification, such a mollusk is also a target of fishing and is included in the target fish.

These fish recognize the presence of the fishing line by recognizing color and brightness. In particular, even in the case of a transparent fishing line, fish can recognize the presence of the fishing line by recognizing brightness. In the present invention, it can be said that the fish hardly recognize the presence of the fishing line by using a fishing line in which the spectral transmittance of the fishing line in a predetermined wavelength range and the relationship between the yarn diameter and the spectral transmittance are in a specific range, and thus the catch can be improved.

As described above, in the fishing line having a spectral transmittance of 13% to 40% at a wavelength of 425 nm to 575 nm, the amount of light transmitted through the fishing line in the wavelength region is small. The fishing line is less likely to transmit light in the wavelength region (fish that can identify color have relatively high photosensitivity in the wavelength region of 425 nm to 575 nm), and thus is less likely to be recognized by various fish species that can identify color. As a result, it is estimated that a good catch can be expected for fish that can identify color. In particular, a fishing line in which the difference (maximum value−minimum value) between the maximum value and the minimum value of the spectral transmittance at the wavelength of 425 nm to 575 nm is within 13% is considered to be effective for various fish species because the transmission amount of light in the above wavelength range does not change significantly.

Furthermore, in the case of a fishing line having a spectral reflectance of 26% or less at a wavelength of 425 nm to 700 nm, the amount of light reflected by the fishing line is small. For this reason, it is considered that the fish hardly recognize the fishing line by the light reflected by the fishing line. In particular, in a fishing line in which the difference between the maximum value and the minimum value of the spectral reflectance at a wavelength of 425 nm to 700 nm (maximum value−minimum value) is 9% or less, the same amount of light is reflected in substantially the entire visible light region. Therefore, the light reflected by the fishing line becomes substantially white light, thus making it difficult for the fish to distinguish the fishing line from the water area around the fishing line (although there is a difference in brightness between the fishing line and the water area around the fishing line, it is difficult to distinguish the fishing line from the water area around the fishing line by the difference in brightness in water where light is difficult to reach). For this reason, it is considered that the fish hardly recognize the fishing line by the reflected light. As a result, it is estimated that a good catch can be expected for various fish species.

In general, it has been said that the use of a fishing line having a smaller yarn diameter increases the catch. The present inventors have assumed that whether the catch is good or not is determined based on not only the yarn diameter of the fishing line, but the spectral transmittance of the fishing line is also an important factor, and conducted repeated trial and error. As a result, the present inventors have found that a good catch can be expected for various fish species by the fact that the spectral transmittance L0Z of the fishing line at a wavelength of 525 nm satisfies the relationship of Formula (4): 25.1X^{-0.23}<L0Z<12.9X^{-0.38}. This is a matter that the present inventors have found for the first time. The reason why the spectral transmittance is based on light having a wavelength of 525 nm is that saltwater fish are highly sensitive to light having a wavelength of 520 nm as described above.

### [Method for Producing Fishing Line]

The fishing line can be produced by making a forming material containing a colorant and a resin component into yarn.

The yarn making process includes at least one step selected from the following steps (a) to (e):
(a) a step of melt-spinning a forming material containing a resin component;
(b) a step of solution-spinning a liquid forming material containing a resin component;
(c) a step of further drawing the yarn obtained by spinning (for example, the melt spinning or solution spinning, and the like) a forming material containing a resin component;
(d) a step of braiding a plurality of yarns obtained by spinning (for example, the melt spinning or solution spinning, and the like) a forming material containing a resin component to form a braided yarn, or fusing a plurality of yarns to form a fused yarn; and
(e) a step of attaching an oil agent, a dye, or the like to one or a plurality of yarns obtained by spinning (for example, the melt spinning or solution spinning, and the like) a forming material containing a resin component.

In the method for producing a fishing line of the present invention, a spectral transmittance of the fishing line at a wavelength of 425 nm to 575 nm is within a range of 13% to 40%, and a spectral transmittance L0Z of the fishing line at a wavelength of 525 nm satisfies 25.1X^{-0.23}<L0Z<12.9X^{-0.38} where X represents a diameter (mm) of the fishing line.

Since the main factor that affects the optical characteristics of the fishing line is the colorant, the colorant may be selected based on the following criteria.

As described above, a pigment or a dye can be used as the colorant, but a pigment is preferably used, and an organic pigment is more preferably used because a fishing line having high color fastness can be formed. Typical examples of the red organic pigment include azo-based pigment naphthol AS-based, and azo-based pigment perylene-based pigments. Examples of the yellow organic pigment include azo-based pigment pyrazolone-based pigments. Examples of the blue organic pigment include azo-based pigment anthraquinone-based, condensed polycyclic pigment phthalocyanine-based, and condensed polycyclic pigment indigo-based pigments. Examples of the orange pigment include condensed polycyclic pigment perinone-based pigments, and examples of the purple organic pigment include condensed polycycic pigment quinacridone-based pigments. In general, a red organic pigment has a sharp absorption peak around a wavelength of 520 nm, a yellow organic pigment has a sharp absorption peak around a wavelength of 450 nm, and a blue organic pigment has a sharp absorption peak around a wavelength of 580 nm.

As a simple method for producing the fishing line satisfying the above optical characteristics, two or more kinds of organic pigments are used. Preferably, at least two of red pigments, yellow pigments, and blue pigments, which are three primary colors of colors, are selected and used. For example, it is preferable to use a colorant containing 35 to 55% by weight of a red organic pigment, 20 to 40% by weight of a yellow organic pigment, and 15 to 35% by weight of a blue organic pigment based on 100% by weight of the total amount of the colorant. It is more preferable to use a colorant containing 40 to 50% by weight of a red organic pigment, 25 to 35% by weight of a yellow organic pigment, and 20 to 30% by weight of a blue organic pigment.

The addition amount of the colorant is appropriately set. In order to produce the fishing line satisfying the optical characteristics, it is preferable to set the addition amount of the colorant as follows in relation to the yarn diameter of the fishing line. For example, in the case of producing a fishing line having a yarn diameter of less than 0.2 mm, 100 to 250 ppm, preferably 160 to 220 ppm of the colorant is added in the entire forming material of the fishing line. Further, in the case of producing a fishing line having a yarn diameter of 0.2 mm or more and less than 0.3 mm, 60 to 150 ppm, preferably 80 to 120 ppm of the colorant is added. In the case of producing a fishing line having a yarn diameter of 0.5 mm or more and less than 1.2 mm, 20 to 65 ppm, preferably 30 to 60 ppm of the colorant is added. In the case of producing a fishing line having a yarn diameter of 1.2 mm or more and less than 1.6 mm, 5 to 45 ppm, preferably 10 to 40 ppm of the colorant is added. In the case of producing a fishing line having a yarn diameter of 1.6 mm or more and less than 2.5 mm, 3 to 25 ppm, preferably 5 to 20 ppm of the colorant is added.

As the resin component, as described above, a vinylidene-based resin such as polyvinylidene fluoride, an olefin-based resin such as high molecular weight polyethylene, a polyamide-based resin, a polyester-based resin, or the like can be used.

As the additive, as described above, a light resistance agent, an ultraviolet absorber, an antioxidant, a crystallization inhibitor, a plasticizer, and the like can be used.

For example, a case where the yarn making of a fishing line made of monofilament of polyvinylidene fluoride-based resin is performed by melt spinning in the above (a) will be briefly described as an example.

A resin composition (forming material) is prepared by mixing the colorant and, if necessary, an additive with a polyvinylidene fluoride-based resin. The resin composition is filled in, for example, a hopper of an extruder type spinning machine, melt-extruded from a spinneret at a temperature of 220 °C to 290 °C, an extrusion pressure of 1 to 50 MPa, and a spinning speed of 0.3 m/min to 300 m/min, and spun. The monofilament spun from the extruder is cooled in a cooling bath. As the cooling bath, a liquid inert to the polyvinylidene fluoride-based resin is used, and for example, glycerin, polyethylene glycol, water, a mixed liquid thereof, or the like is used. The monofilament after cooling is drawn and heat-set. The drawing may be single-stage drawing, but is usually multi-stage drawing. The heat treatment in the drawing and heat setting is not particularly limited, and examples thereof include passing the filament through a dry heat space in a heat atmosphere such as an oven or hot air, or immersing the filament in a heat medium bath such as silicone oil. The total draw ratio is, for example, 5 times to 7 times.

### [Method for Evaluating Fishing Line]

In another point of view, the present invention provides a method for evaluating a fishing line. The method for evaluating a fishing line includes: measuring the spectral transmittance and the diameter of the fishing line; and confirming that the spectral transmittance at a wavelength of 425 nm to 575 nm satisfies 13% to 40%, and the spectral transmittance L0Z at a wavelength of 525 nm satisfies the relationship of 25.1X^{-0.23}<L0Z<12.9X^{-0.38} where X represents the diameter (mm) of the fishing line. By using the fishing line confirmed to satisfy the above relationship, a good catch can be expected for various fish species.

In another point of view, the present invention provides a production method as follows. For example, a fishing line is produced by performing a step of producing a fishing line by making a forming material containing a colorant and a resin component into yarn, an evaluation step of measuring the spectral transmittance and the diameter of the produced fishing line and confirming that the spectral transmittance at a wavelength of 425 nm to 575 nm satisfies 13% to 40% and the spectral transmittance L0Z at a wavelength of 525 nm satisfies the relationship of 25.1X^{-0.23}<L0Z<12.9X^{-0.38}, and a step of mass-producing the fishing line confirmed to satisfy the relationship in the evaluation step. The mass production refers to mass-producing the same fishing line and producing a large number of products.

### EXAMPLES

Hereinafter, the present invention will be further described with reference to Examples and Comparative Examples. Note that the present invention is not limited only to the following examples.

### [Colorant Used]

### <Organic Pigment (A1)>

An organic pigment (A1) is obtained by mixing 30% by weight of an azo-based pigment naphthol AS-based pigment (C.I. Pigment Red 112), 20% by weight of an azo-based pigment pyrazolone-based pigment (C.I. Pigment Yellow 10), 18% by weight of a condensed polycyclic pigment phthalocyanine-based pigment (C.I. Pigment Blue 15) as pigment components, 2% by weight of carbon black as a dull agent, and 30% by weight of magnesium stearate as a dispersant.

### <Dye-Based Coloring Material (B1)>

A dye-based coloring material (B1) is obtained by mixing 84% by weight of a polymethine-based dye (C.I. Basic Red 12), 0.5% by weight of carbon black as a dull agent, 0.5% by weight of magnesium stearate as a dispersant, 0.5% by weight of zinc stearate as a dispersant, and 14.5% by weight of ethylene bis stearamide as a lubricant.

### <Dye (C1)>

A dye (C1) is a dye solution (concentration: 2% by weight) in which a cationic dye (KAYACRYL RED GRL-ED: manufactured by Nippon Kayaku Co., Ltd.) is dissolved.

### [Method for Measuring Spectral Transmittance L0]

As shown in FIG. 4, a fishing line to be measured was single-wound around a slide glass for an optical microscope without any gap, and fixed so as not to be detached. Hereinafter, in this section, a slide glass in which a fishing line is single-wound without a gap is referred to as a “sample plate”.

### <Measurement of Spectral Reflectance L1>

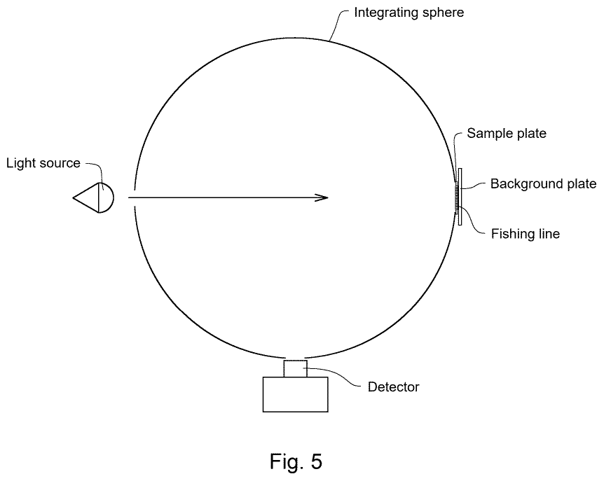

As shown in FIG. 5, the sample plate was placed on the surface of a white background plate, and fixed so as not to move, and the sample plate was set so that the fishing line would come out in a window portion of a commercially available integrating sphere device. Using a commercially available spectrophotometer (trade name “V-650” manufactured by JASCO Corporation), a light source (halogen lamp) and a detector thereof were arranged as shown in FIG. 5. Light was emitted from the light source to a region where the fishing line of the sample plate was dense, and reflected light was detected by the detector. The spectral reflectance L1 was measured from the intensity of light from the light source and the intensity of the reflected light. The measurement wavelength was in a range of 400 nm to 750 nm, and the measurement was performed at a bandwidth of 5 nm and a pitch of 0.5 nm.

The reflected light here includes light reflected by the fishing line and light transmitted through the fishing line and reflected by the white background plate. Therefore, the spectral reflectance L1 is equal to the sum of the spectral reflectance of the light reflected by the fishing line and the spectral reflectance of the light transmitted through the fishing line and reflected by the white background plate.

### <Measurement of Spectral Reflectance L2>

The spectral reflectance L2 was measured in the same manner as in <Measurement of spectral reflectance L1> described above except that a black background plate was used instead of the white background plate.

The reflected light here includes light reflected by the fishing line (because the light transmitted through the fishing line is absorbed by the black background plate). Therefore, the spectral reflectance L2 is equal to the spectral reflectance of the light reflected by the fishing line.

### <Calculation of Spectral Transmittance L0>

The spectral transmittance L0 of the fishing line was obtained by subtracting the spectral reflectance L2 from the spectral reflectance L1.

Spectral transmittance of fishing line L0=L1−L2

### [Method for Measuring Diameter of Fishing Line]

The diameter (mm) of the fishing line was measured using a micrometer manufactured by Mitutoyo Corporation. For the measurement, the diameters of arbitrary five points along the length direction of the fishing line were measured, and the average value thereof was adopted as the diameter (mm).

### [Tensile Breaking Strength and Tensile Elongation]

According to the specification of JIS L 1013, the fishing line was left to stand for 24 hours in a temperature and humidity control room at 20 °C and 65% RH. Then, tensile breaking strength and tensile elongation (tensile elongation is elongation at break) were measured using a tensile tester (trade name “AUTOGRAPH S-500D” manufactured by Shimadzu Corporation) under the conditions of a sample length of 300 mm and a tensile speed of 300 mm/min. The tensile breaking strength and the tensile elongation were measured five times with respect to one fishing line. The average value thereof was adopted as the tensile breaking strength (N) and the tensile elongation (%).

### [Knot Breaking Strength]

According to the specification of JIS L 1013, the fishing line was tightly knotted once with a square knot. This was used as a test object, and the knot breaking strength was measured in the same manner as in the above [Tensile breaking strength and tensile elongation] by using a tensile tester (trade name “AUTOGRAPH S-500D” manufactured by Shimadzu Corporation) after the test object was left to stand for 24 hours in a temperature and humidity control room. The knot breaking strength was measured five times with respect to one fishing line, and the average value thereof was adopted as the knot breaking strength (N).

### Example 1

Polyvinylidene fluoride homopolymer chips containing 160 ppm of the organic pigment (A1) were supplied to a spinning machine, and heated to 260 °C to melt the chips. The molten material was extruded from a spinneret having a hole diameter of 0.6 mm, and cooled in a bath at 90 °C to obtain an undrawn monofilament. The obtained undrawn monofilament was drawn 5.0 times in a heat medium bath at 160 °C to obtain a one-stage drawn yarn. Subsequently, the one-stage drawn yarn was further drawn in a dry heat tank at 160 °C to obtain a two-stage drawn yarn which was drawn at a draw ratio of 5.7 times in total from the undrawn yarn. Furthermore, the two-stage drawn yarn was heat-set while being shrunk 0.95 times in a dry heat tank at 160 °C to produce a fishing line (colored polyvinylidene fluoride monofilament) having a diameter of 0.12 mm.

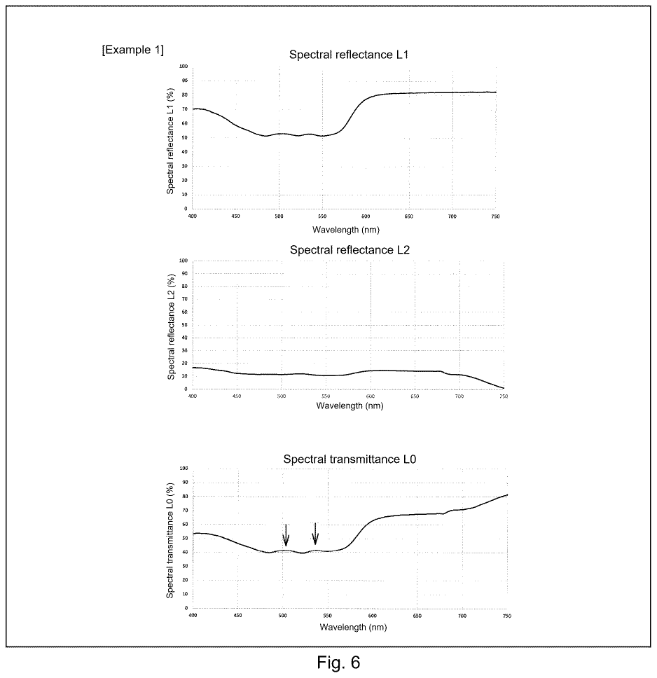

The spectral transmittance of the fishing line of Example 1 was measured. The results are shown in FIG. 6. As shown in FIG. 6, there were a plurality of peaks of the spectral transmittance L0 (arrows are drawn for indicating the peaks in FIG. 6). Table 1 shows the maximum value (A) and the minimum value (B) of the spectral transmittance L0 at a wavelength of 425 nm to 575 nm, the difference between the maximum value and the minimum value (A−B), and the spectral transmittance L0Z at a wavelength of 525 nm. Furthermore, Table 1 shows the maximum value (C) and the minimum value (D) of the spectral transmittance L0 at a wavelength of 575 nm to 700 nm and the difference between the maximum value and the minimum value (C−D). Table 1 also shows the maximum value (E) and the minimum value (F) of the spectral reflectance L2 at a wavelength of 425 nm to 700 nm and the difference between the maximum value and the minimum value (E−F).

Furthermore, the diameter of the fishing line, tensile breaking strength, tensile elongation, and knot breaking strength of Example 1 were measured. The results are shown in Table 1.

TABLE 1

| | | Unit | Example 1 | Example 2 | Example 3 | Example 4 | Example 5 | Example 6 |
|---|---|---|---|---|---|---|---|---|
| Colorants | Organic pigment (A1) | ppm | 160 | 190 | 220 | 80 | 120 | 50 |
| | Dye-based coloring material (B1) | ppm | — | — | — | — | — | — |
| | Dye (C1) | | — | — | — | — | — | — |
| Conditions | Yarn diameter | mm | 0.12 | 0.12 | 0.12 | 0.25 | 0.25 | 0.40 |
| | Hole diameter of spinneret | mm | 0.6 | 0.6 | 0.6 | 0.8 | 0.8 | 1.4 |
| | Draw ratio | Times | 5.7 | 5.7 | 5.7 | 6.0 | 6.0 | 6.0 |
| Optical | A: Maximum value of spectral | % | 40 | 39 | 38 | 37 | 36 | 35 |
| characteristics | transmittance L0 at wavelength | | | | | | | |
| | of 425 nm to 575 nm | | | | | | | |
| | B: Minimum value of spectral | % | 32 | 27 | 25 | 29 | 25 | 27 |
| | transmittance L0 at wavelength | | | | | | | |
| | of 425 nm to 575 nm | | | | | | | |
| | A − B | % | 8 | 12 | 13 | 8 | 11 | 8 |
| | Spectral transmittance L0Z at | % | 38 | 34 | 30 | 29 | 25 | 27 |
| | wavelength of 525 nm | | | | | | | |
| | C: Maximum value of spectral | % | 71 | 69 | 67 | 51 | 58 | 49 |
| | transmittance L0 at wavelength | | | | | | | |
| | of 575 nm to 700 nm | | | | | | | |
| | D: Minimum value of spectral | % | 46 | 38 | 40 | 50 | 32 | 35 |
| | transmittance L0 at wavelength | | | | | | | |
| | of 575 nm to 700 nm | | | | | | | |
| | C − D | % | 25 | 31 | 27 | 1 | 26 | 14 |
| | E: Maximum value of spectral | % | 15 | 16 | 17 | 21 | 20 | 19 |
| | reflectance L2 at wavelength | | | | | | | |
| | of 425 nm to 700 nm | | | | | | | |
| | F: Minimum value of spectral | % | 11 | 9 | 11 | 16 | 14 | 15 |
| | reflectance L2 at wavelength | | | | | | | |
| | of 425 nm to 700 nm | | | | | | | |
| | E − F | % | 4 | 7 | 6 | 5 | 6 | 4 |
| Physical | Tensile breaking strength | N | 12 | 14 | 12 | 40 | 41 | 93 |
| properties | Tensile elongation | % | 23.3 | 22.2 | 25 | 23 | 24 | 25 |
| | Knot breaking strength | N | 7.4 | 7.3 | 7.6 | 27 | 28 | 57 |

| | | Unit | Example 7 | Example 8 | Example 9 | Example 10 | Example 11 |
|---|---|---|---|---|---|---|---|
| Colorants | Organic pigment (A1) | ppm | 65 | 80 | 45 | 55 | 40 |
| | Dye-based coloring material (B1) | ppm | — | — | — | — | — |
| | Dye (C1) | | — | — | — | — | — |
| Conditions | Yarn diameter | mm | 0.40 | 0.40 | 0.44 | 0.44 | 0.72 |
| | Hole diameter of spinneret | mm | 1.4 | 1.4 | 1.6 | 1.6 | 2.4 |
| | Draw ratio | Times | 6.0 | 6.0 | 6.0 | 6.0 | 5.9 |
| Optical | A: Maximum value of spectral | % | 35 | 30 | 38 | 36 | 23 |
| characteristics | transmittance L0 at wavelength | | | | | | |
| | of 425 nm to 575 nm | | | | | | |
| | B: Minimum value of spectral | % | 25 | 20 | 29 | 27 | 17 |
| | transmittance L0 at wavelength | | | | | | |
| | of 425 nm to 575 nm | | | | | | |
| | A − B | % | 10 | 10 | 9 | 9 | 6 |
| | Spectral transmittance L0Z at | % | 25 | 20 | 29 | 27 | 17 |
| | wavelength of 525 nm | | | | | | |
| | C: Maximum value of spectral | % | 51 | 47 | 51 | 52 | 34 |
| | transmittance L0 at wavelength | | | | | | |
| | of 575 nm to 700 nm | | | | | | |
| | D: Minimum value of spectral | % | 34 | 28 | 37 | 35 | 22 |
| | transmittance L0 at wavelength | | | | | | |
| | of 575 nm to 700 nm | | | | | | |
| | C − D | % | 17 | 19 | 14 | 17 | 12 |
| | E: Maximum value of spectral | % | 19 | 19 | 19 | 20 | 16 |
| | reflectance L2 at wavelength | | | | | | |
| | of 425 nm to 700 nm | | | | | | |
| | F: Minimum value of spectral | % | 14 | 15 | 15 | 15 | 12 |
| | reflectance L2 at wavelength | | | | | | |
| | of 425 nm to 700 nm | | | | | | |
| | E − F | % | 4 | 5 | 4 | 5 | 4 |
| Physical | Tensile breaking strength | N | 91 | 93 | 110 | 108 | 274 |
| properties | Tensile elongation | % | 26 | 27 | 24 | 25 | 28 |
| | Knot breaking strength | N | 56 | 55 | 75 | 74 | 167 |

TABLE 2

| | | | Exam- | Exam- | Exam- | Exam- | Exam- | Exam- | Exam- |
|---|---|---|---|---|---|---|---|---|---|
| | | Unit | ple 12 | ple 13 | ple 14 | ple 15 | ple 16 | ple 17 | ple 18 |
| Colorants | Organic pigment (A1) | ppm | 30 | 30 | 40 | 50 | 60 | 10 | 20 |
| | Dye-based coloring material (B1) | ppm | — | — | — | — | — | — | — |
| | Dye (C1) | | — | — | — | — | — | — | — |
| Conditions | Yarn diameter | mm | 1.02 | 1.02 | 1.02 | 1.02 | 1.02 | 1.54 | 1.54 |
| | Hole diameter of spinneret | mm | 3.0 | 3.0 | 3.0 | 3.0 | 3.0 | 5.0 | 5.0 |
| | Draw ratio | Times | 5.8 | 5.9 | 5.9 | 5.9 | 5.9 | 5.9 | 5.9 |
| Optical | A: Maximum value of spectral | % | 26 | 28 | 26 | 24 | 22 | 27 | 24 |
| characteristics | transmittance L0 at wavelength | | | | | | | | |
| | of 425 nm to 575 nm | | | | | | | | |
| | B: Minimum value of spectral | % | 20 | 22 | 18 | 14 | 13 | 18 | 17 |
| | transmittance L0 at wavelength | | | | | | | | |
| | of 425 nm to 575 nm | | | | | | | | |
| | A − B | % | 6 | 6 | 8 | 10 | 9 | 9 | 7 |
| | Spectral transmittance LOZ at | % | 20 | 22 | 19 | 16 | 13 | 20 | 17 |
| | wavelength of 525 nm | | | | | | | | |
| | C: Maximum value of spectral | % | 42 | 45 | 44 | 43 | 43 | 36 | 36 |
| | transmittance L0 at wavelength | | | | | | | | |
| | of 575 nm to 700 nm | | | | | | | | |
| | D: Minimum value of spectral | % | 26 | 27 | 23 | 20 | 16 | 27 | 23 |
| | transmittance L0 at wavelength | | | | | | | | |
| | of 575 nm to 700 nm | | | | | | | | |
| | C − D | % | 16 | 18 | 21 | 23 | 27 | 9 | 13 |
| | E: Maximum value of spectral | % | 25 | 22 | 22 | 21 | 21 | 23 | 22 |
| | reflectance L2 at wavelength | | | | | | | | |
| | of 425 nm to 700 nm | | | | | | | | |
| | F: Minimum value of spectral | % | 17 | 14 | 12 | 10 | 9 | 19 | 15 |
| | reflectance L2 at wavelength | | | | | | | | |
| | of 425 nm to 700 nm | | | | | | | | |
| | E − F | % | 8 | 8 | 10 | 11 | 12 | 4 | 7 |
| Physical | Tensile breaking strength | N | 539 | 510 | 519 | 549 | 549 | 1127 | 1078 |
| properties | Tensile elongation | % | 26 | 26.7 | 27.3 | 26.8 | 28.7 | 27.6 | 27.9 |
| | Knot breaking strength | N | 304 | 304 | 304 | 314 | 314 | 608 | 608 |

| | | | Exam- | Exam- | Exam- | Exam- | Exam- | Exam- |
|---|---|---|---|---|---|---|---|---|
| | | Unit | ple 19 | ple 20 | ple 21 | ple 22 | ple 23 | ple 24 |
| Colorants | Organic pigment (A1) | ppm | 30 | 40 | 2 | 5 | 10 | 20 |
| | Dye-based coloring material (B1) | ppm | — | — | — | — | — | — |
| | Dye (C1) | | — | — | — | — | — | — |
| Conditions | Yarn diameter | mm | 1.54 | 1.54 | 2.10 | 2.10 | 2.10 | 2.10 |
| | Hole diameter of spinneret | mm | 5.0 | 5.0 | 7.0 | 7.0 | 7.0 | 7.0 |
| | Draw ratio | Times | 5.9 | 5.9 | 5.9 | 5.9 | 5.9 | 5.9 |
| Optical | A: Maximum value of spectral | % | 22 | 20 | 19 | 18 | 17 | 16 |
| characteristics | transmittance L0 at wavelength | | | | | | | |
| | of 425 nm to 575 nm | | | | | | | |
| | B: Minimum value of spectral | % | 15 | 14 | 15 | 14 | 13 | 13 |
| | transmittance L0 at wavelength | | | | | | | |
| | of 425 nm to 575 nm | | | | | | | |
| | A − B | % | 7 | 6 | 4 | 4 | 4 | 3 |
| | Spectral transmittance LOZ at | % | 15 | 12 | 19 | 16 | 14 | 13 |
| | wavelength of 525 nm | | | | | | | |
| | C: Maximum value of spectral | % | 32 | 33 | 28 | 29 | 29 | 29 |
| | transmittance L0 at wavelength | | | | | | | |
| | of 575 nm to 700 nm | | | | | | | |
| | D: Minimum value of spectral | % | 15 | 13 | 24 | 23 | 19 | 14 |
| | transmittance L0 at wavelength | | | | | | | |
| | of 575 nm to 700 nm | | | | | | | |
| | C − D | % | 17 | 20 | 4 | 6 | 10 | 15 |
| | E: Maximum value of spectral | % | 23 | 22 | 22 | 21 | 20 | 20 |
| | reflectance L2 at wavelength | | | | | | | |
| | of 425 nm to 700 nm | | | | | | | |
| | F: Minimum value of spectral | % | 12 | 10 | 19 | 18 | 16 | 12 |
| | reflectance L2 at wavelength | | | | | | | |
| | of 425 nm to 700 nm | | | | | | | |
| | E − F | % | 11 | 12 | 3 | 3 | 4 | 8 |
| Physical | Tensile breaking strength | N | 1186 | 1117 | 2127 | 2156 | 1950 | 1890 |
| properties | Tensile elongation | % | 28.1 | 26.8 | 25.9 | 26.2 | 27.7 | 25.7 |
| | Knot breaking strength | N | 627 | 598 | 960 | 960 | 980 | 930 |

### Examples 2 to 24

A fishing line of each of Examples 2 to 24 was prepared in the same manner as in Example 1 except that at least one selected from the amount of the organic pigment (A1), the hole diameter of the spinneret, and the draw ratio was changed as shown in Tables 1 and 2. When the hole diameter of the spinneret is changed, the diameter of the fishing line to be obtained is changed.

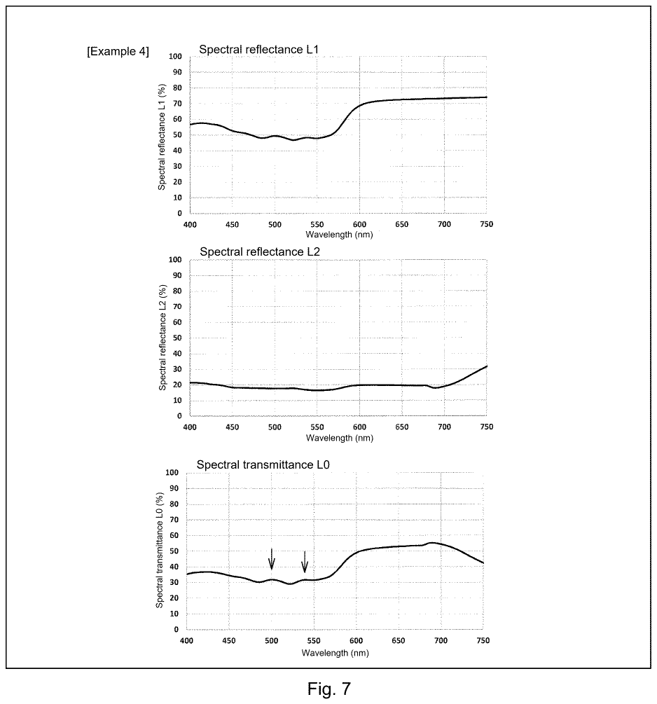

The spectral transmittance of each of the fishing lines of Examples 2 to 24 was also measured. The results of Example 4 are shown in FIG. 7. As shown in FIG. 7, there were a plurality of peaks of the spectral transmittance L0 (arrows are drawn for indicating the peaks in FIG. 7).

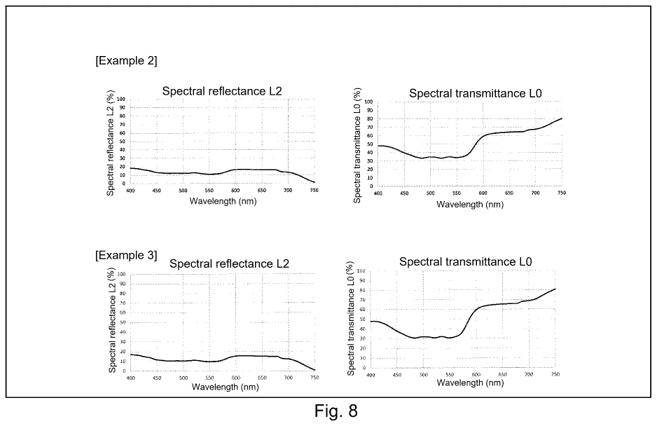

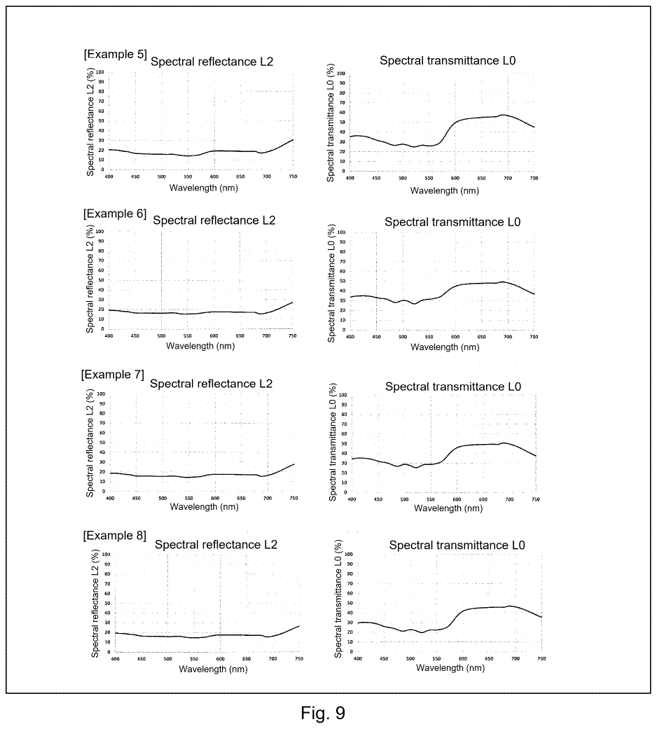

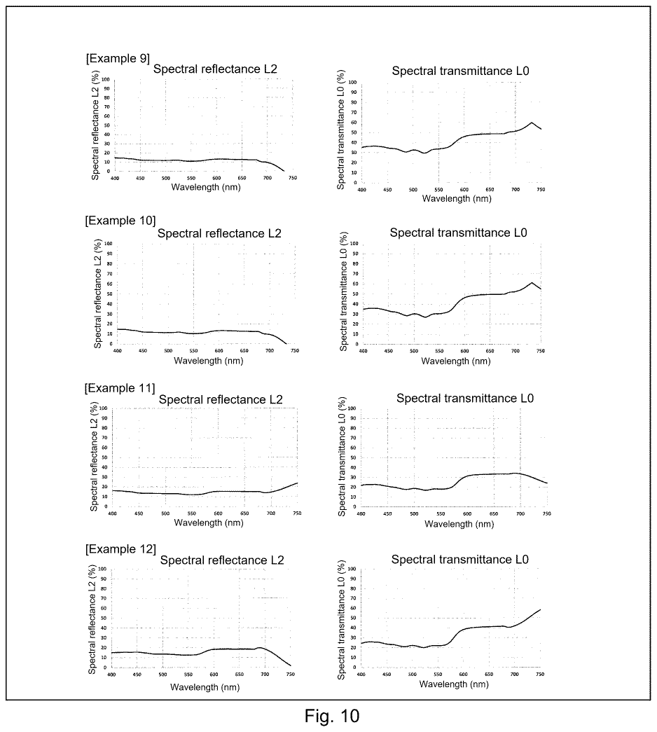

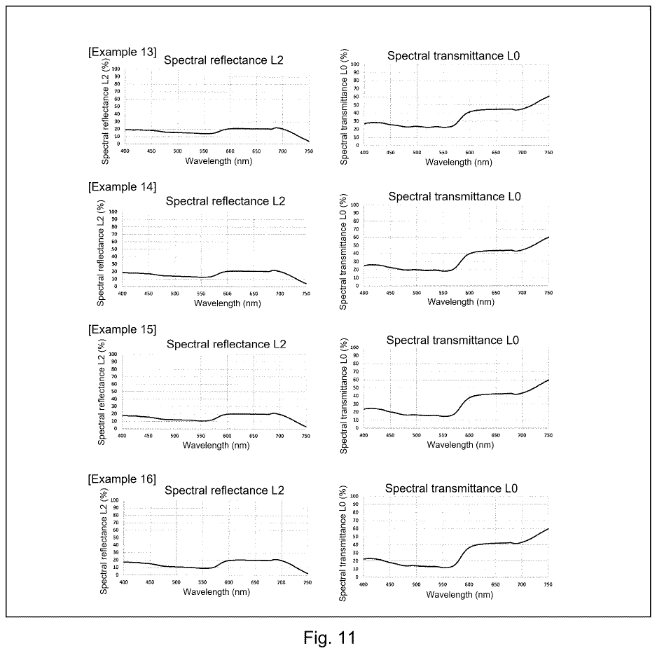

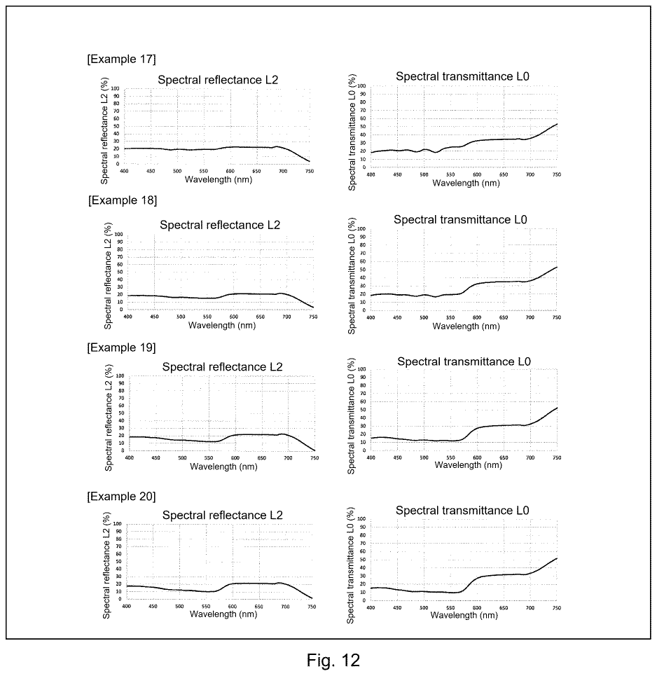

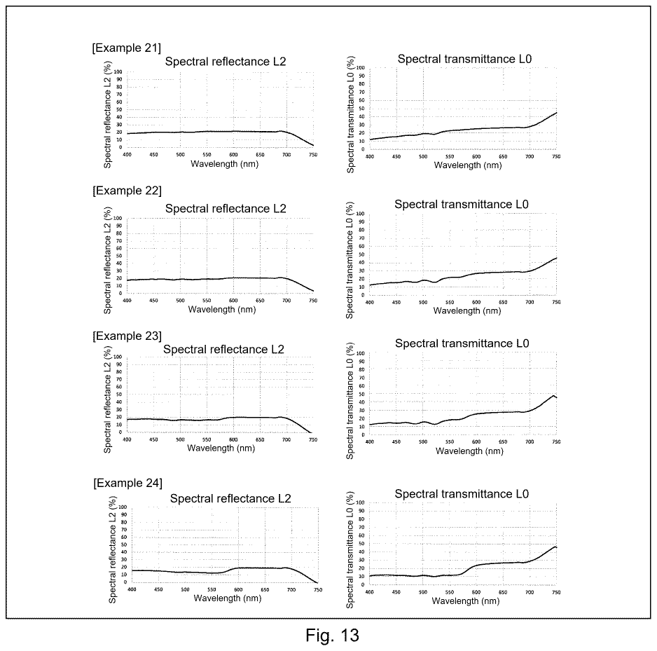

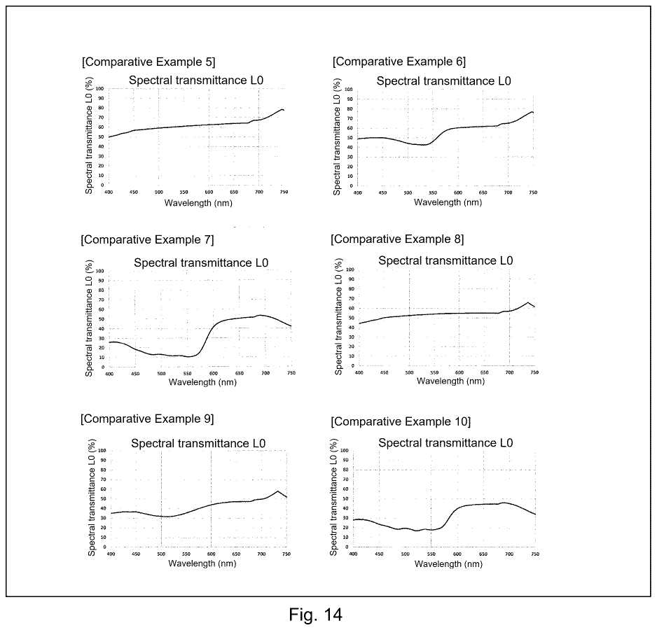

The results of measuring the spectral transmittance of each of the fishing lines of Examples 2, 3, and 5 to 24 are shown in FIGS. 8 to 13. FIGS. 8 to 13 show graphs of spectral reflectance L2 and graphs of spectral transmittance L0 of the respective fishing lines of Examples 2, 3, and 5 to 24. As described above, the spectral reflectance L2 is a reflectance including only light reflected from the fishing line. As shown in FIGS. 8 to 13, there were a plurality of peaks of the spectral transmittance L0. Further, Table 1 and Table 2 show the maximum value and the minimum value of the spectral transmittance L0 at a wavelength of 425 nm to 575 nm, the difference between the maximum value and the minimum value (A−B), and the spectral transmittance L0Z at a wavelength of 525 nm. Table 1 and Table 2 also show the maximum value (C) and the minimum value (D) of the spectral transmittance L0 at a wavelength of 575 nm to 700 nm, the difference between the maximum value and the minimum value (C−D), the maximum value (E) and the minimum value (F) of the spectral reflectance L2 at a wavelength of 425 nm to 700 nm and the difference between the maximum value and the minimum value (E−F) of Examples 2 to 24.

Furthermore, the diameter of the fishing line, tensile breaking strength, tensile elongation, and knot breaking strength of Examples 2 to 24 were measured. The results are shown in Table 1 and Table 2.

### Comparative Examples 1 to 4

A fishing line of each of Comparative Examples 1 to 4 having a diameter of 0.12 mm was prepared in the same manner as in Example 1 except that the amount of the organic pigment (A1) was changed.

### Comparative Example 5

A fishing line (colored polyvinylidene fluoride monofilament) of Comparative Example 5 having a diameter of 0.25 mm was prepared in the same manner as in Example 4 except that the organic pigment (A1) was not blended (see Table 3).

### Comparative Example 6

A fishing line (colored polyvinylidene fluoride monofilament) of Comparative Example 6 having a diameter of 0.25 mm was prepared in the same manner as in Example 4 except that the dye (C1) was used instead of the organic pigment (A1) (see Table 3).

Specifically, a fishing line (uncolored polyvinylidene fluoride monofilament) having a diameter of 0.25 mm was prepared without blending the organic pigment (A1) (colorant). The fishing line was passed through a bath, which had a length of 3 m and was filled with the dye (C1), at a speed of 20 m/min and then dried to prepared a fishing line of Comparative Example 6. The temperature of the dye (C1) in the bath (container) was set to 80 °C.

### Comparative Example 7

A fishing line (colored polyvinylidene fluoride monofilament) of Comparative Example 7 having a diameter of 0.25 mm was prepared in the same manner as in Example 4 except that the amount of the organic pigment (A1) was changed (see Table 3).

### Comparative Example 8

A fishing line of Comparative Example 8 having a diameter of 0.4 mm was prepared in the same manner as in Example 6 except that the organic pigment (A1) was not blended (see Table 3).

### Comparative Example 9

A fishing line of Comparative Example 9 having a diameter of 0.4 mm was prepared in the same manner as in Example 6 except that the predetermined amount of the dye-based coloring material (B1) was blended instead of the organic pigment (A1) (see Table 3).

### Comparative Examples 10 and 11

Fishing lines of Comparative Examples 10 and 11 having a diameter of 0.4 mm were prepared in the same manner as in Example 6 except that the amount of the organic pigment (A1) was changed (see Table 3).

### Comparative Examples 12 to 14

Fishing lines of Comparative Examples 12 to 14 having a diameter of 0.44 mm were prepared in the same manner as in Example 9 except that the organic pigment (A1) was not blended, the predetermined amount of the dye-based coloring material (B1) was blended instead of the organic pigment (A1), or the amount of the organic pigment (A1) was changed (see Table 4).

### Comparative Example 15

A fishing line of Comparative Example 15 having a diameter of 0.72 mm was prepared in the same manner as in Example 11 except that the organic pigment (A1) was not blended (see Table 4).

### Comparative Examples 16 to 21

Fishing lines of Comparative Examples 16 to 21 having a diameter of 1.02 mm were prepared in the same manner as in Example 12 except that the organic pigment (A1) was not blended, the amount of the organic pigment (A1) was changed, or the draw ratio was changed (see Table 4).

### Comparative Examples 22 to 25

Fishing lines of Comparative Examples 22 to 25 having a diameter of 1.54 mm were prepared in the same manner as in Example 17 except that the organic pigment (A1) was not blended or the amount of the organic pigment (A1) was changed (see Table 5).

### Comparative Examples 26 to 29

Fishing lines of Comparative Examples 26 to 29 having a diameter of 2.1 mm were prepared in the same manner as in Example 21 except that the organic pigment (A1) was not blended or the amount of the organic pigment (A1) was changed (see Table 5).

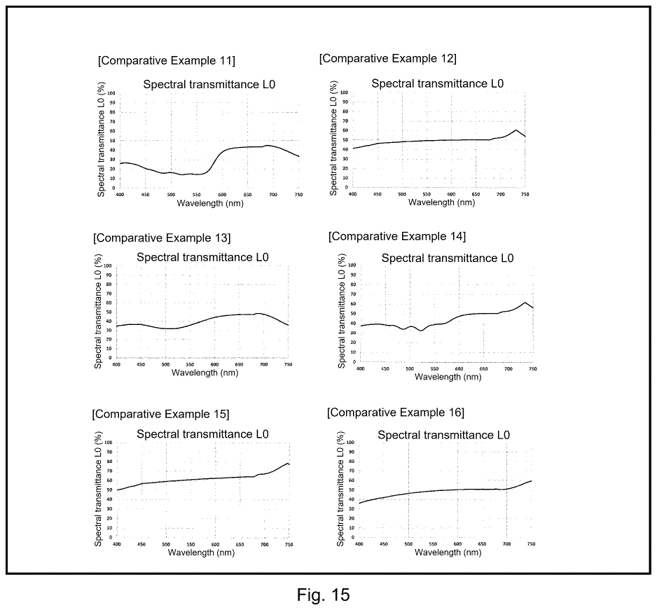

The spectral transmittance of each of the fishing lines of Comparative Examples 1 to 29 was also measured. Graphs of the spectral transmittance L0 of each of the fishing lines of Comparative Examples 5 to 16 were shown in FIG. 14 and FIG. 15. Note that the graphs of Comparative Examples 1 to 4 and 17 to 29 are omitted.

Tables 3 to 5 also shows the maximum value and the minimum value of the spectral transmittance L0 at a wavelength of 425 nm to 575 nm, the difference between the maximum value and the minimum value (A−B), and the spectral transmittance L0Z at a wavelength of 525.

Furthermore, the diameter of the fishing line, tensile breaking strength, tensile elongation, and knot breaking strength of Comparative Examples 1 to 29 were measured. The results are shown in Table 3 to Table 5.

TABLE 3

| | | | Comparative | Comparative | Comparative | Comparative | Comparative | Comparative |
|---|---|---|---|---|---|---|---|---|
| | | Unit | Example 1 | Example 2 | Example 3 | Example 4 | Example 5 | Example 6 |
| Colorants | Organic pigment (A1) | ppm | 40 | 100 | 280 | 340 | — | — |
| | Dye-based coloring material | ppm | — | — | — | — | — | — |
| | (B1) | | | | | | | |
| | Dye (C1) | | — | — | — | — | — | Used |
| Conditions | Yarn diameter | mm | 0.12 | 0.12 | 0.12 | 0.12 | 0.25 | 0.25 |
| | Hole diameter of spinneret | mm | 0.6 | 0.6 | 0.6 | 0.6 | 0.8 | 0.8 |
| | Draw ratio | Times | 5.7 | 5.7 | 5.7 | 5.7 | 6.0 | 6.0 |
| Optical | A: Maximum value of spectral | % | 60 | 50 | 36 | 35 | 62 | 57 |
| charac- | transmittance L0 at wavelength | | | | | | | |
| teristics | of 425 nm to 575 nm | | | | | | | |
| | B: Minimum value of spectral | % | 50 | 42 | 21 | 17 | 53 | 42 |
| | transmittance L0 at wavelength | | | | | | | |
| | of 425 nm to 575 nm | | | | | | | |
| | A − B | % | 10 | 8 | 15 | 18 | 9 | 15 |
| | Spectral transmittance L0Z at | % | 52 | 42 | 28 | 25 | 44 | 42 |
| | wavelength of 525 nm | | | | | | | |
| Physical | Tensile breaking strength | N | 13 | 13 | 12 | 14 | 41 | 37 |
| properties | Tensile elongation | % | 22.5 | 26.6 | 23.1 | 22.4 | 26 | 28 |
| | Knot breaking strength | N | 7.4 | 9.5 | 7.3 | 7.8 | 27 | 25 |

| | | | Comparative | Comparative | Comparative | Comparative | Comparative |
|---|---|---|---|---|---|---|---|
| | | Unit | Example 7 | Example 8 | Example 9 | Example 10 | Example 11 |
| Colorants | Organic pigment (A1) | ppm | 250 | — | — | 100 | 120 |
| | Dye-based coloring material | ppm | — | — | 24 | — | — |
| | (B1) | | | | | | |
| | Dye (C1) | | — | — | — | — | — |
| Conditions | Yarn diameter | mm | 0.25 | 0.40 | 0.40 | 0.40 | 0.40 |
| | Hole diameter of spinneret | mm | 0.8 | 1.4 | 1.4 | 1.4 | 1.4 |
| | Draw ratio | Times | 6.0 | 6.0 | 6.0 | 6.0 | 6.0 |
| Optical | A: Maximum value of spectral | % | 25 | 54 | 48 | 28 | 26 |
| charac- | transmittance L0 at wavelength | | | | | | |
| teristics | of 425 nm to 575 nm | | | | | | |
| | B: Minimum value of spectral | % | 10 | 47 | 40 | 17 | 14 |
| | transmittance L0 at wavelength | | | | | | |
| | of 425 nm to 575 nm | | | | | | |
| | A − B | % | 15 | 7 | 8 | 11 | 12 |
| | Spectral transmittance L0Z at | % | 11 | 54 | 37 | 17 | 14 |
| | wavelength of 525 nm | | | | | | |
| Physical | Tensile breaking strength | N | 37 | 91 | 93 | 94 | 91 |
| properties | Tensile elongation | % | 28 | 26 | 27 | 25 | 23 |
| | Knot breaking strength | N | 25 | 56 | 55 | 57 | 55 |

TABLE 4

| | | | Comparative | Comparative | Comparative | Comparative | Comparative |
|---|---|---|---|---|---|---|---|
| | | Unit | Example 12 | Example 13 | Example 14 | Example 15 | Example 16 |
| Colorants | Organic pigment (A1) | ppm | — | — | 30 | — | — |
| | Dye-based coloring material (B1) | ppm | — | 24 | — | — | — |
| | Dye (C1) | | — | — | — | — | — |
| Conditions | Yarn diameter | mm | 0.44 | 0.44 | 0.44 | 0.72 | 1.02 |
| | Hole diameter of spinneret | mm | 1.6 | 1.6 | 1.6 | 2.4 | 3.0 |
| | Draw ratio | Times | 6.0 | 6.0 | 6.0 | 5.9 | 5.8 |
| Optical | A: Maximum value of spectral | % | 50 | 40 | 42 | 48 | 50 |
| characteristics | transmittance L0 at wavelength | | | | | | |
| | of 425 nm to 575 nm | | | | | | |
| | B: Minimum value of spectral | % | 44 | 32 | 33 | 42 | 40 |
| | transmittance L0 at wavelength | | | | | | |
| | of 425 nm to 575 nm | | | | | | |
| | A − B | % | 6 | 8 | 8 | 6 | 10 |
| | Spectral transmittance L0Z at | % | 44 | 32 | 33 | 46 | 48 |
| | wavelength of 525 nm | | | | | | |
| Physical | Tensile breaking strength | N | 108 | 108 | 107 | 284 | 539 |
| properties | Tensile elongation | % | 27 | 26 | 26 | 27 | 26 |
| | Knot breaking strength | N | 76 | 76 | 75 | 167 | 304 |
| | | | Comparative | Comparative | Comparative | Comparative | Comparative |
| | | Unit | Example 17 | Example 18 | Example 19 | Example 20 | Example 21 |
| Colorants | Organic pigment (A1) | ppm | — | 10 | 20 | 70 | 80 |
| | Dye-based coloring material (B1) | ppm | — | — | — | — | — |
| | Dye (C1) | | — | — | — | — | — |
| Conditions | Yarn diameter | mm | 1.02 | 1.02 | 1.02 | 1.02 | 1.02 |
| | Hole diameter of spinneret | mm | 3.0 | 3.0 | 3.0 | 3.0 | 3.0 |
| | Draw ratio | Times | 5.9 | 5.9 | 5.9 | 5.9 | 5.9 |
| Optical | A: Maximum value of spectral | % | 45 | 36 | 32 | 22 | 18 |
| characteristics | transmittance L0 at wavelength | | | | | | |
| | of 425 nm to 575 nm | | | | | | |
| | B: Minimum value of spectral | % | 40 | 28 | 26 | 13 | 9 |
| | transmittance L0 at wavelength | | | | | | |
| | of 425 nm to 575 nm | | | | | | |
| | A − B | % | 5 | 8 | 6 | 9 | 9 |
| | Spectral transmittance L0Z at | % | 43 | 29 | 26 | 11 | 9 |
| | wavelength of 525 nm | | | | | | |
| Physical | Tensile breaking strength | N | 530 | 539 | 559 | 510 | 510 |
| properties | Tensile elongation | % | 27.2 | 27.3 | 26.5 | 25.7 | 26.3 |
| | Knot breaking strength | N | 314 | 314 | 294 | 304 | 304 |

TABLE 5

| | | | Comparative | Comparative | Comparative | Comparative |
|---|---|---|---|---|---|---|
| | | Unit | Example 22 | Example 23 | Example 24 | Example 25 |
| Colorants | Organic pigment (A1) | ppm | — | 50 | 2 | 5 |
| | Dye-based coloring material (B1) | ppm | — | — | — | — |
| | Dye (C1) | | — | — | — | — |
| Conditions | Yarn diameter | mm | 1.54 | 1.54 | 1.54 | 1.54 |
| | Hole diameter of spinneret | mm | 5.0 | 5.0 | 5.0 | 5.0 |
| | Draw ratio | Times | 5.9 | 5.9 | 5.9 | 5.9 |
| Optical | A: Maximum value of spectral | % | 36 | 14 | 33 | 32 |
| characteristics | transmittance L0 at wavelength | | | | | |
| | of 425 nm to 575 nm | | | | | |
| | B: Minimum value of spectral | % | 25 | 8 | 23 | 24 |
| | transmittance L0 at wavelength | | | | | |
| | of 425 nm to 575 nm | | | | | |
| | A − B | % | 11 | 6 | 10 | 8 |
| | Spectral transmittance L0Z at | % | 27 | 8 | 25 | 25 |
| | wavelength of 525 nm | | | | | |
| Physical | Tensile breaking strength | N | 1127 | 1117 | 1137 | 1107 |
| properties | Tensile elongation | % | 27.1 | 27.8 | 26.7 | 25.8 |
| | Knot breaking strength | N | 588 | 598 | 598 | 578 |
| | | | Comparative | Comparative | Comparative | Comparative |
| | | Unit | Example 26 | Example 27 | Example 28 | Example 29 |
| Colorants | Organic pigment (A1) | ppm | — | 30 | 40 | 50 |
| | Dye-based coloring material (B1) | ppm | — | — | — | — |
| | Dye (C1) | | — | — | — | — |
| Conditions | Yarn diameter | mm | 2.10 | 2.10 | 2.10 | 2.10 |
| | Hole diameter of spinneret | mm | 7.0 | 7.0 | 7.0 | 7.0 |
| | Draw ratio | Times | 5.9 | 5.9 | 5.9 | 5.9 |
| Optical | A: Maximum value of spectral | % | 25 | 14 | 13 | 12 |
| characteristics | transmittance L0 at wavelength | | | | | |
| | of 425 nm to 575 nm | | | | | |
| | B: Minimum value of spectral | % | 16 | 10 | 8 | 6 |
| | transmittance L0 at wavelength | | | | | |
| | of 425 nm to 575 nm | | | | | |
| | A − B | % | 9 | 4 | 5 | 6 |
| | Spectral transmittance L0Z at | % | 23 | 11 | 9 | 8 |
| | wavelength of 525 nm | | | | | |
| Physical | Tensile breaking strength | N | 2019 | 1617 | 1980 | 1872 |
| properties | Tensile elongation | % | 28.8 | 22.7 | 25.1 | 24.8 |
| | Knot breaking strength | N | 960 | 935 | 951 | 931 |

### [Actual Fishing Test]

Sea fishing was actually carried out using the fishing lines of Examples and Comparative Examples, and the catches were evaluated.

### <Test (1)>

Tip Run fishing (a method of squid fishing by detecting bites on the tip of the rod) was carried out from a ship in the sea of Imari City, Saga Prefecture, on Apr. 17, 2023. Four anglers as testers conducted the test for two hours from 6:00 AM to 8:00 AM.

Testers are professional anglers that test fishing equipment and are also called field testers (hereinafter, the same shall apply). Tip Run fishing is a fishing method of targeting mainly bigfin reef squid hidden in the sea floor by using a rig in which several meters of a shock leader is tied to the tip of a main line and a lure for tip run is tied to the tip of the shock leader.

In the present test (1), an ultra-high molecular weight polyethylene line having a diameter of 0.13 mm was used as a main line, and the length of the shock leader was set to 2 m. Then, two testers used the fishing line of Example 4 as a shock leader, and the remaining two testers used the fishing line of Comparative Example 5 (diameter: 0.25 mm) as a shock leader. The reason why the fishing line of Example 4 and the fishing line of Comparative Example 5 were selected is that they had the same diameter (0.25 mm). When fishing lines having different diameters are used, there is a possibility that the catch changes due to the difference in diameter, and thus the example and the comparative example having the same diameter were selected.

The catches are shown in Table 6.

TABLE 6

| | | | | Average |
|---|---|---|---|---|
| | | Fish species | Number of | number of |
| | Angler | caught | catches | catches |
| Example 4 | First tester | Bigfin reef squid | 2 | 2 |
| | Second tester | Bigfin reef squid | 2 | |
| Comparative | Third tester | Bigfin reef squid | 1 | 1 |
| Example 5 | Fourth tester | Bigfin reef squid | 1 | |

As shown in Table 6, when the fishing line of Example 4 was used, the catch was superior to that when the fishing line of Comparative Example 5 was used.

According to the document (Nippon Suisan Gakkaishi 80 (2), 245 (2014)), it is estimated that the maximum absorption wavelength of the bigfin reef squid is 494 nm, and the bigfin reef squid does not have color vision but can perceive light in an absorption wavelength region of rhodopsin. The fishing line of Example 4 is less likely to transmit light having a wavelength of 425 nm to 575 nm than the fishing line of Comparative Example 5. Therefore, the fishing line of Example 4 is less likely to be perceived as compared with Comparative Example 5, and the present inventors estimate that it is possible to suppress the wariness of the bigfin reef squid and improve the catch.

### <Test (2)>

Tairaba fishing was carried out from a ship in the sea of Imari City, Saga Prefecture, on Apr. 17, 2023. Three anglers as testers were conducted the test for 8 hours from 8:00 AM to 4:00 PM.

Tairaba fishing is a fishing method of targeting mainly sea bream and other various fish species, in which several meters of a shock leader is tied to the tip of a main line, and a rig consisting of four parts of a weight, a thin band-shaped film, a thin string, and a fish hook is tied to the tip of the shock leader (hereinafter, the same shall apply).

In the present test (2), an ultra-high molecular weight polyethylene line having a diameter of 0.15 mm was used as a main line, and the length of the shock leader was set to 3 m. Then, one tester used the fishing line of Example 7 (diameter: 0.40 mm) as a shock leader, and the remaining two testers used the fishing line of Comparative Example 8 (diameter: 0.40 mm) as a shock leader. The reason why the fishing line of Example 7 and the fishing line of Comparative Example 8 were selected is that they had the same diameter (0.40 mm).

The catches are shown in Table 7.

TABLE 7

| | | Fish species caught and Number of catches | | | | | | | |
|---|---|---|---|---|---|---|---|---|---|
| | | | Red-spotted | Golden threadfin | Yellow | | Areolate | Number of | Average number |
| | Angler | Sea bream | grouper | bream | grouper | Lizardfish | grouper | fish species | of catches |
| Example 7 | First tester | 2 | 2 | — | 3 | 1 | 1 | 5 | 9 |
| Comparative | Second tester | — | 1 | 2 | 1 | — | — | 3 | 6 |
| Example 8 | Third tester | 2 | — | 1 | 3 | 2 | — | 4 | |

As shown in Table 7, when the fishing line of Example 7 was used, various fish species were caught and the number of catches was larger than that when the fishing line of Comparative Example 8 was used.

### <Test (3)>

Tairaba fishing was carried out from a ship in the sea of Imari City, Saga Prefecture, on Apr. 28, 2023. Six anglers as testers were conducted the test for 10 hours from 6:00 AM to 4:00 PM.

In the present test (3), an ultra-high molecular weight polyethylene line having a diameter of 0.15 mm was used as a main line, and the length of the shock leader was set to 3 m. Then, two testers used the fishing line of Example 8 (diameter: 0.40 mm) as a shock leader, and the remaining two testers used the fishing line of Comparative Example 9 (diameter: 0.40 mm) as a shock leader. On the boat, each angler was arranged so that anglers using the same shock leader were not adjacent to each other. The reason why the fishing line of Example 8 and the fishing lines of Comparative Examples 8 and 9 were selected is that the diameter (0.40 mm) was the same.

The catches are shown in Table 8.

TABLE 8

| | | Fish species caught and Number of catches | | | | | | | | |
|---|---|---|---|---|---|---|---|---|---|---|
| | | | | | Golden | | Seven | | | |
| | | | Red-spotted | Marbled | threadfin | Yellow | band | | Horse | Young |
| | Angler | Sea bream | grouper | rockfish | bream | grouper | grouper | Lizardfish | mackerel | yellowtail |
| Example 8 | First tester | 5 | 3 | 2 | 1 | 1 | 1 | — | — | — |
| | Second tester | 3 | 3 | — | 3 | 1 | — | 1 | — | — |
| Comparative | Third tester | 1 | 1 | 2 | 1 | 2 | — | — | — | — |
| Example 8 | Fourth tester | 3 | 3 | 3 | 1 | 1 | — | — | — | — |
| Comparative | Fifth tester | 3 | 2 | 1 | — | — | — | — | 1 | — |
| Example 9 | Sixth tester | 2 | 3 | 1 | 1 | — | — | — | — | 1 |

| | | Fish species caught and Number of catches | | | | |
|---|---|---|---|---|---|---|
| | | Areolate | Emperor | Number of | Total number | Average number |
| | Angler | grouper | fish | fish species | of fish species | of catches |
| Example 8 | First tester | — | — | 6 | 8 | 13 |
| | Second tester | — | 2 | 6 | | |
| Comparative | Third tester | — | — | 5 | 5 | 9 |
| Example 8 | Fourth tester | — | — | 5 | | |
| Comparative | Fifth tester | — | — | 4 | 7 | 8 |
| Example 9 | Sixth tester | 1 | — | 6 | | |

As shown in Table 8, when the fishing line of Example 8 was used, various fish species were caught and the number of catches was larger than that when the fishing lines of Comparative Examples 8 and 9 were used.

### <Test (4)>

On May 16, 2023, testers landed on the rocky reef off Ikitsuki, Hirado City, Nagasaki Prefecture, and Fukase fishing was carried out. Four anglers as testers conducted the test for 8 hours from 6:00 AM to 2:00 PM.

Fukase fishing is a fishing method in which a float is attached to a main line, the main line is extended by a length corresponding to a water depth for fishing from the float, about 2 m to 3 m of a leader is tied to the tip of the main line, a fish hook is tied to the tip of the leader, and a bait such as krill is attached to the fish hook. Fukase fishing is a fishing method of reading the bite that appears on a float and hooking fish on a fish hook by a so-called hooking operation.

In the present test (4), the target fish was set as largescale blackfish, a nylon line having a diameter of 0.23 mm was used as the main line, and the length of the leader was 3 m. Then, (a) a fishing rod using the fishing line of Example 4 as a leader, (b) a fishing rod using the fishing line of Comparative Example 5 as a leader, (c) a fishing rod using the fishing line of Comparative Example 6 as a leader, and (d) a fishing rod using the fishing line of Comparative Example 7 as a leader were prepared.

Four testers performed fishing by sequentially changing the fishing rods of (a) to (d) every hour (for example, from 6:00 AM to 7:00 AM, the first tester, the second tester, the third tester, and the fourth tester fish with a fishing rod (a), a fishing rod (b), a fishing rod (c), and a fishing rod (d), respectively, from 7:00 AM to 8:00 AM, the first tester, the second tester, the third tester, and the fourth tester fish with a fishing rod (d), a fishing rod (a), a fishing rod (b), and a fishing rod (c), respectively . . . ). The locations of the testers were exchanged to each other so that the same tester was not fixed to one place (fishing seat). The reason why the fishing line of Example 4 and the fishing lines of Comparative Examples 5 to 7 were selected is that the diameter (0.25 mm) was the same.

Table 9 shows the number of catches of largescale blackfish and the number of catches of fish other than largescale blackfish when the respective fishing lines of Examples and Comparative Examples are used. It is to be noted that fish other than largescale blackfish were chicken grunt, small red sea bream, and marbled rockfish.

In Table 9, “Excellent” in the column of the evaluation of the fishing line represents a fishing line with the highest number of catches, “Good” represents a fishing line in which the number of catches is 75% or more of the highest number of catches, “Fair” represents a fishing line in which the number of catches is 50% or more and 75% or less of the highest number of catches, and “Poor” represents a fishing line in which the number of catches is less than 50% of the highest number of catches (hereinafter, the same applies to each Table).

TABLE 9

| | | Comparative | Comparative | Comparative |
|---|---|---|---|---|
| | Example 4 | Example 5 | Example 6 | Example 7 |
| Number of catches of | 24 | 17 | 17 | 12 |
| largescale blackfish | | | | |
| Number of catches of fish | 11 | 6 | 7 | 5 |
| other than largescale blackfish | | | | |
| Total number of catches of fish | 35 | 23 | 24 | 17 |
| Evaluation of fishing line | Excellent | Fair | Fair | Poor |

### <Test (5)>

Vertical Contact Ajing (lure fishing for horse mackerel) was carried out from a ship in the sea of Imari City, Saga Prefecture, on May 11, 2023. Five anglers as testers conducted the test for 5 hours from 6:00 PM to 11:00 PM.

Vertical Contact Ajing is a fishing method of targeting mainly horse mackerel and various other fish species, in which several meters of a leader are tied to the tip of a main line, a weight is attached to the tip of the leader, a branch line having a length of 5 to 30 cm is tied to the leader at a position several tens of centimeters above the weight, several grams of a jig head are attached to the tip of the branch line, and a ragworm or an artificial bait (resin worm and the like) is attached to the jig head.

In the present test (5), an ultra-high molecular weight polyethylene line having a diameter of 0.15 mm was used as the main line, and the length of the leader was 2 m and the length of the branch line was 20 cm. Then, (e) a fishing rod using the fishing line of Example 4 as a leader and a branch line, (f) a fishing rod using the fishing line of Example 5 as a leader and a branch line, (g) a fishing rod using the fishing line of Comparative Example 5 as a leader and a branch line, (h) a fishing rod using the fishing line of Comparative Example 6 as a leader and a branch line, and (i) a fishing rod using the fishing line of Comparative Example 7 as a leader and a branch line were prepared.

Five testers performed fishing by sequentially changing the fishing rods of (e) to (i) every hour in the same manner as in Test (4). The locations of the testers were exchanged to each other so that the same tester was not fixed to one place (fishing seat) on the boat. In the present test (5), fishing was carried out while illuminating with a fish lamp after darkening. The reason why the fishing lines of Examples 4 and 5 and the fishing lines of Comparative Examples 5 to 7 were selected is that the diameter (0.25 mm) was the same.

Table 10 shows the number of catches of horse mackerel and the number of catches of fish other than horse mackerel when the respective fishing lines of Examples and Comparative Examples are used. The fish other than horse mackerel were lizardfish and marbled rockfish.

As is apparent from the present test (5), it can be seen that the fishing lines of Examples are excellent in catch even when fishing is performed under a fish lamp.

TABLE 10

| | | | Comparative | Comparative | Comparative |
|---|---|---|---|---|---|
| | Example 4 | Example 5 | Example 5 | Example 6 | Example 7 |
| Number of catches of | 13 | 11 | 8 | 8 | 7 |
| horse mackerel | | | | | |
| Number of catches of fish | 3 | 2 | 1 | 2 | 0 |
| other than horse mackerel | | | | | |
| Total number of | 16 | 13 | 9 | 10 | 7 |
| catches of fish | | | | | |
| Evaluation of fishing line | Excellent | Good | Fair | Fair | Poor |

### <Test (6)>

Bait fishing was carried out on a fishing pier at a fish farm in Sasebo City, Nagasaki Prefecture, on May 11, 2023. Seven anglers as testers conducted the test for 7 hours from 7:00 AM to 2:00 PM.

Bait fishing is a fishing method in which a float is attached to a main line, the main line is extended by a length corresponding to a water depth for fishing from the float, 30 cm to 2 m of a leader is tied to the tip of the main line, a fish hook is tied to the tip of the leader, and a live bait (insects or crustaceans) or a paste bait is attached to the fish hook. The bait fishing is a fishing method of reading the bite that appears on a float and hooking fish on a fish hook by a so-called hooking operation.

In the present test (6), an ultra-high molecular weight polyethylene line having a diameter of 0.24 mm was used as the main line, and the length of the leader was 1.5 m. Then, (j) a fishing rod using the fishing line of Example 6 as a leader, (k) a fishing rod using the fishing line of Example 7 as a leader, (l) a fishing rod using the fishing line of Example 8 as a leader, (m) a fishing rod using the fishing line of Comparative Example 8 as a leader, (n) a fishing rod using the fishing line of Comparative Example 9 as a leader, (o) a fishing rod using the fishing line of Comparative Example 10 as a leader, and (p) a fishing rod using the fishing line of Comparative Example 11 as a leader were prepared.

Seven testers performed fishing by sequentially changing the fishing rods of (j) to (p) every hour in the same manner as in Test (4). The locations of the testers were exchanged to each other so that the same tester was not fixed to one place (fishing seat) on the boat. The reason why the fishing lines of Examples 6 to 8 and the fishing lines of Comparative Examples 8 to 11 were selected is that the diameter (0.40 mm) was the same.

Table 11 shows the number of catches of sea bream and the number of catches of fish other than sea bream when the respective fishing lines of Examples and Comparative Examples are used. Incidentally, fish other than sea bream were greater amberjack, ray, and grouper.

TABLE 11

| | | | | Comparative | Comparative | Comparative | Comparative |
|---|---|---|---|---|---|---|---|
| | Example 6 | Example 7 | Example 8 | Example 8 | Example 9 | Example 10 | Example 11 |
| Number of catches of | 16 | 13 | 12 | 7 | 7 | 10 | 9 |
| sea bream | | | | | | | |
| Number of catches of fish | 0 | 1 | 1 | 2 | 0 | 1 | 2 |
| other than sea bream | | | | | | | |
| Total number of catches | 16 | 14 | 13 | 9 | 7 | 11 | 11 |
| of fish | | | | | | | |
| Evaluation of fishing line | Excellent | Good | Good | Fair | Poor | Fair | Fair |

### <Test (7)>

Jigging was carried out from a ship in the sea of the Tango Peninsula, Maizuru City, Kyoto Prefecture, on Apr. 27, 2023. Five anglers as testers conducted the test for 5 hours from 9:00 AM to 2:00 PM.

Jigging is a fishing method of targeting mainly yellowtail and various other fish species, in which several meters of a leader is tied to the tip of a main line, and a lure (called a metallic jig) is attached to the tip of the leader. Jigging is a fishing method of checking a fish shadow with a fish finder by a captain, dropping a lure to a designated water depth according to an instruction of the captain, and moving a fishing rod up and down from the water depth to make the lure jig in the sea and hook the fish on the lure.

In the present test (7), an ultra-high molecular weight polyethylene line having a diameter of 0.24 mm was used as the main line, and the length of the leader was 7.5 m. Then, (q) a fishing rod using the fishing line of Example 9 as a leader, (r) a fishing rod using the fishing line of Example 10 as a leader, (s) a fishing rod using the fishing line of Comparative Example 12 as a leader, (t) a fishing rod using the fishing line of Comparative Example 13 as a leader, and (u) a fishing rod using the fishing line of Comparative Example 14 as a leader were prepared.

Five testers performed fishing by sequentially changing the fishing rods of (q) to (u) every hour in the same manner as in Test (4). The locations of the testers were exchanged to each other so that the same tester was not fixed to one place (fishing seat) on the boat. The reason why the fishing lines of Examples 9 and 10 and the fishing lines of Comparative Examples 12 to 14 were selected is that the diameter (0.44 mm) was the same.

Table 12 shows the number of catches of yellowtail and the number of catches of fish other than yellowtail when the respective fishing lines of Examples and Comparative Examples are used. The fish other than yellowtail were sea bream and young yellowtail. Those having a body length of 80 cm or more were determined as yellowtail, and those having a body length of less than 80 cm were determined as young yellowtail.

TABLE 12

| | | | Comparative | Comparative | Comparative |
|---|---|---|---|---|---|
| | Example 9 | Example 10 | Example 12 | Example 13 | Example 14 |
| Number of catches of | 2 | 1 | 1 | 0 | 0 |
| yellowtail | | | | | |
| Number of catches of fish | 4 | 5 | 3 | 3 | 2 |
| other than yellowtail | | | | | |
| Total number of | 6 | 6 | 4 | 3 | 2 |
| catches of fish | | | | | |
| Evaluation of fishing line | Excellent | Excellent | Fair | Fair | Poor |

### <Test (8)>

Tonbo jigging was carried out from a ship in the sea of Daiosaki Cape, Shima City, Mie Prefecture, on Apr. 9, 2023. Two anglers as testers conducted the test for 6 hours from 7:00 AM to 1:00 PM.

Tonbo jigging is a rig and a fishing method similar to the above jigging, and is a fishing method of targeting mainly albacore, in which several meters of a leader is tied to the tip of a main line, and a lure (called a metallic jig) is attached to the tip of the leader (hereinafter, the same shall apply).

In the present test (8), an ultra-high molecular weight polyethylene line having a diameter of 0.34 mm was used as the main line, and the length of the leader was 7.5 m. Then, (v) a fishing rod using the fishing line of Example 11 as a leader, and (w) a fishing rod using the fishing line of Comparative Example 15 as a leader were prepared.

Two testers performed fishing by sequentially changing the fishing rods of (v) and (w) every hour in the same manner as in Test (4). The locations of the testers were exchanged to each other so that the same tester was not fixed to one place (fishing seat) on the boat. The reason why the fishing line of Example 11 and the fishing line of Comparative Example 15 were selected is that the diameter (0.72 mm) was the same.

Table 13 shows the number of catches of albacore and the number of catches of fish other than albacore when the respective fishing lines of Example and Comparative Example are used. Incidentally, the fish other than albacore was bonito.

TABLE 13

| | | Comparative |
|---|---|---|
| | Example 11 | Example 15 |
| Number of catches of | 0 | 0 |
| albacore of 10 kg or more | | |
| Number of catches of | 4 | 2 |
| albacore of less than 10 kg | | |
| Number of catches of fish | 2 | 0 |
| other than albacore | | |
| Total number of catches of fish | 6 | 2 |
| Evaluation of fishing line | Excellent | Poor |

### <Test (9)>

Tonbo jigging was carried out from a ship in the sea of Oshima, Kushimoto Town, Higashimuro-gun, Wakayama Prefecture, on Jan. 22, 2023. Two anglers as testers conducted the test for 6 hours from 7:00 AM to 1:00 PM.

In the present test (9), an ultra-high molecular weight polyethylene line having a diameter of 0.34 mm was used as the main line, and the length of the leader was 7.5 m. Then, (x) a fishing rod using the fishing line of Example 12 as a leader, and (y) a fishing rod using the fishing line of Comparative Example 16 as a leader were prepared.

Two testers performed fishing by sequentially changing the fishing rods of (x) and (y) every hour in the same manner as in Test (4). The locations of the testers were exchanged to each other so that the same tester was not fixed to one place (fishing seat) on the boat. The reason why the fishing line of Example 12 and the fishing line of Comparative Example 16 were selected is that the diameter (1.02 mm) was the same.

Table 14 shows the number of catches of albacore and the number of catches of fish other than albacore when the respective fishing lines of Example and Comparative Example are used. Incidentally, the fish other than albacore was blue marlin.

TABLE 14

| | | Comparative |
|---|---|---|
| | Example 12 | Example 16 |
| Number of catches of | 2 | 0 |
| albacore of 10 kg or more | | |
| Number of catches of | 1 | 1 |
| albacore of less than 10 kg | | |
| Number of catches of fish | 1 | 0 |
| other than albacore | | |
| Total number of catches of fish | 4 | 1 |
| Evaluation of fishing line | Excellent | Poor |

### <Test (10)>

Rockfish fishing was carried out from a ship in the sea of Imari City, Saga Prefecture, on Mar. 19, 2024. Eight anglers as testers conducted the test for 8 hours from 6:00 AM to 2:00 PM.

In the fishing method in the present test (10), a squid cut into strips of 1 cm×7 cm as bait was attached to a hook, and rockfish and the like living mainly on the sea floor were targeted.

In the present test (10), the following rig was used.

An ultra-high molecular weight polyethylene line having a diameter of 0.15 mm was used as a main line, and a shock leader (diameter 0.37 mm) (commercially available transparent fluorocarbon leader having a length of 1.5 m and a diameter of 0.37 mm) was tied to the tip of the main line. A three-pronged swivel was attached to the tip of a shock leader, a commercially available fluorocarbon leader having a length of 1.5 m and a diameter of 0.29 mm was tied to one loop of the three-pronged swivel, and a weight was attached to the tip of the leader. A fishing line for a test having a length of 1 m was detachably attached to the other loop of the three-pronged swivel with Power Stainless Swivel.

As the fishing line for a test, the fishing lines of Examples 21 to 24 and Comparative Examples 26 to 29 (all of the fishing lines had a diameter of 2.10 mm) were used.

Eight testers performed fishing by changing fishing lines for each test every hour. Specifically, for example, fishing is carried out using a rig in which the fishing line of Example 21 is attached to the other loop of the three-pronged swivel until 1 hour after the start, and fishing is carried out using a rig in which the fishing line of Example 22 is attached to the other loop of the three-pronged swivel instead of the fishing line of Example 21 during a time period from 1 hour to 2 hours after the start. The locations of the testers were exchanged to each other so that the same tester was not fixed to one place (fishing seat) on the boat.

In Table 15, the catches when the respective fishing lines of Examples and Comparative Examples were used are summarized for each fish species. Note that, in the column of fish species in Table 15, “a” represents marbled rockfish, “b” represents yellowbarred red rockfish, and “c” represents red-spotted grouper. When the maximum total number of catches is 100%, the ratio of the total number of catches to the maximum total number of catches is shown in the table (the same applies to Tables 16 to 19 below).

As is apparent from the table, in the fishing lines of Examples, the ratio of the total number of catches is 70% or more. Therefore, the catches of the fishing lines of Examples are superior to those of the fishing lines of Comparative Examples. In particular, in Example 22, not only the number of catches was high, but also a plurality of large red-spotted groupers of 30 cm or more were caught. Presumably, there is a wavelength in a specific range that suppresses the foraging instinct of the red-spotted grouper, but it is considered that the foraging instinct of the wary red-spotted grouper was not suppressed due to absorption of light of the wavelength in the specific range by the fishing line of Example 22.

TABLE 15

| | | | | | | | | | | | | | Comparative | |
|---|---|---|---|---|---|---|---|---|---|---|---|---|---|---|
| | Example 21 | | | Example 22 | | | Example 23 | | | Example 24 | | | Example 26 | |
| Fish species | a | b | c | a | b | c | a | b | c | a | b | c | a | b |
| Number of catches | 4 | 3 | 3 | 4 | 3 | 6 | 4 | 3 | 4 | 4 | 3 | 3 | 2 | 2 |
| Total number of catches | 10 | | | 13 | | | 11 | | | 10 | | | 6 | |
| Number of catches of | 1 | | | 3 | | | 2 | | | 1 | | | 0 | |
| red-spotted grouper of | | | | | | | | | | | | | | |
| 30 cm or more | | | | | | | | | | | | | | |
| Ratio of total number of | 77 | | | 100 | | | 85 | | | 77 | | | 45 | |
| catches to maximum | | | | | | | | | | | | | | |
| total number of | | | | | | | | | | | | | | |
| catches (Example 22) (%) | | | | | | | | | | | | | | |

| | Comparative | Comparative | | | Comparative | | | Comparative | | |
|---|---|---|---|---|---|---|---|---|---|---|
| | Example 26 | Example 27 | | | Example 28 | | | Example 29 | | |
| Fish species | c | a | b | c | a | b | c | a | b | c |
| Number of catches | 2 | 3 | 2 | 2 | 2 | 0 | 2 | 2 | 1 | 0 |
| Total number of catches | 6 | 7 | | | 4 | | | 3 | | |
| Number of catches of | 0 | 0 | | | 0 | | | 0 | | |
| red-spotted grouper of | | | | | | | | | | |
| 30 cm or more | | | | | | | | | | |
| Ratio of total number of | 45 | 53 | | | 31 | | | 23 | | |
| catches to maximum | | | | | | | | | | |
| total number of | | | | | | | | | | |
| catches (Example 22) (%) | | | | | | | | | | |

### <Test (11)>

Rockfish fishing was carried out from a ship in the sea of Hirado City, Nagasaki Prefecture, on Apr. 12, 2024. Eight anglers as testers conducted the test for 8 hours from 6:00 AM to 2:00 PM.

The fishing method in the present test (11) was the same as that in the test (10), and the rig was the same as that in the test (10). As the fishing line for a test, the fishing lines of Examples 17 to 20 and Comparative Examples 22 to 25 (all of the fishing lines had a diameter of 1.54 mm) were used.

Eight testers performed fishing by changing the fishing line for each test in the same manner as in the test (10) every hour.

In Table 16, the catches when the respective fishing lines of Examples and Comparative Examples were used are summarized for each fish species. Note that, in the column of fish species in Table 16, “a” represents marbled rockfish, “b” represents yellowbarred red rockfish, “c” represents red-spotted grouper, and “d” represents red sea bream.

As is apparent from the table, in the fishing lines of Examples, the ratio of the total number of catches is 70% or more. Therefore, the catches of the fishing lines of Examples are superior to those of the fishing lines of Comparative Examples. In particular, in Example 19, not only the number of catches was high, but also a plurality of large red-spotted groupers of 30 cm or more were caught. This is considered to be the same reason as in the test (10).

TABLE 16

| | | | | | | | | | | | | | | | | | Comparative | |
|---|---|---|---|---|---|---|---|---|---|---|---|---|---|---|---|---|---|---|
| | Example 17 | | | | Example 18 | | | | Example 19 | | | | Example 20 | | | | Example 22 | |
| Fish species | a | b | c | d | a | b | c | d | a | b | c | d | a | b | c | d | a | b |
| Number of catches | 7 | 4 | 3 | 1 | 8 | 4 | 2 | 2 | 10 | 4 | 4 | 2 | 9 | 4 | 3 | 1 | 4 | 1 |

| Total number of catches | 15 | 16 | 20 | 17 | 6 |
|---|---|---|---|---|---|
| Number of catches of | 0 | 1 | 2 | 2 | 0 |
| red-spotted grouper of | | | | | |
| 30 cm or more | | | | | |
| Number of catches of | 1 | 1 | 2 | 0 | 0 |
| red sea bream of | | | | | |
| 30 cm or more | | | | | |
| Ratio of total number of | 70 | 80 | 100 | 85 | 30 |
| catches to maximum | | | | | |
| total number of | | | | | |
| catches (Example 19) (%) | | | | | |

| | Comparative | | Comparative | | | | Comparative | | | | Comparative | | | |
|---|---|---|---|---|---|---|---|---|---|---|---|---|---|---|
| | Example 22 | | Example 23 | | | | Example 24 | | | | Example 25 | | | |
| Fish species | c | d | a | b | c | d | a | b | c | d | a | b | c | d |
| Number of catches | 1 | 0 | 6 | 3 | 1 | 0 | 4 | 1 | 1 | 1 | 5 | 2 | 1 | 1 |

| Total number of catches | 6 | 10 | 7 | 9 |
|---|---|---|---|---|
| Number of catches of | 0 | 0 | 0 | 0 |
| red-spotted grouper of | | | | |
| 30 cm or more | | | | |
| Number of catches of | 0 | 0 | 0 | 0 |
| red sea bream of | | | | |
| 30 cm or more | | | | |
| Ratio of total number of | 30 | 50 | 35 | 45 |
| catches to maximum | | | | |
| total number of | | | | |
| catches (Example 19) (%) | | | | |

### <Test (12)>

Rockfish fishing was carried out from a ship in the sea of Hirado City, Nagasaki Prefecture, on Apr. 20, 2024. Eleven anglers as testers conducted the test for 5 hours 30 minutes from 6:00 AM to 11:30 AM.

The fishing method in the present test (12) was the same as that in the test (10), and the rig was the same as that in the test (10). As the fishing line for a test, the fishing lines of Examples 12 to 16 and Comparative Examples 16 to 21 (all of the fishing lines had a diameter of 1.02 mm) were used.

Eleven testers performed fishing by changing the fishing line for each test in the same manner as in the test (10) every 30 minutes.

In Tables 17 and 18, the catches when the respective fishing lines of Examples and Comparative Examples were used are summarized for each fish species. Note that, in the column of fish species in Table 17, “a” represents marbled rockfish, “b” represents yellowbarred red rockfish, “c” represents red-spotted grouper, and “d” represents red sea bream.

As is apparent from the tables, in the fishing lines of Examples, the ratio of the total number of catches is 70% or more. Therefore, the catches of the fishing lines of Examples are superior to those of the fishing lines of Comparative Examples. In particular, in Examples 14 and 15, not only the number of catches was high, but also a plurality of large red-spotted groupers and red sea breams of 30 cm or more were caught. This is considered to be the same reason as in the test (10).

TABLE 17

| | Example 12 | | | | Example 13 | | | | Example 14 | | | | Example 15 | | | | Example 16 | | | |
|---|---|---|---|---|---|---|---|---|---|---|---|---|---|---|---|---|---|---|---|---|
| Fish species | a | b | c | d | a | b | c | d | a | b | c | d | a | b | c | d | a | b | c | d |
| Number of catches | 9 | 3 | 2 | 2 | 9 | 4 | 2 | 2 | 9 | 5 | 3 | 2 | 10 | 5 | 4 | 3 | 9 | 5 | 3 | 1 |

| Total number of catches | 16 | 17 | 19 | 22 | 18 |
|---|---|---|---|---|---|
| Number of catches of | 1 | 1 | 2 | 2 | 1 |
| red-spotted grouper of | | | | | |
| 30 cm or more | | | | | |
| Number of catches of | 0 | 0 | 2 | 2 | 0 |
| red sea bream of | | | | | |
| 30 cm or more | | | | | |
| Ratio of total number of | 72 | 77 | 82 | 100 | 82 |
| catches to maximum | | | | | |
| total number of | | | | | |
| catches (Example 15) (%) | | | | | |

TABLE 18

| | Comparative | | | | Comparative | | | | Comparative | | | | Comparative | | | | Comparative | | | | Comparative | | | |
|---|---|---|---|---|---|---|---|---|---|---|---|---|---|---|---|---|---|---|---|---|---|---|---|---|
| | Example 16 | | | | Example 17 | | | | Example 18 | | | | Example 19 | | | | Example 20 | | | | Example 21 | | | |
| Fish species | a | b | c | d | a | b | c | d | a | b | c | d | a | b | c | d | a | b | c | d | a | b | c | d |
| Number of catches | 4 | 0 | 1 | 0 | 5 | 1 | 0 | 0 | 5 | 1 | 1 | 0 | 6 | 2 | 1 | 0 | 7 | 3 | 0 | 0 | 6 | 2 | 0 | 0 |

| Total number of catches | 5 | 6 | 7 | 9 | 10 | 8 |
|---|---|---|---|---|---|---|
| Number of catches of | 0 | 0 | 0 | 0 | 0 | 0 |
| red-spotted grouper of | | | | | | |
| 30 cm or more | | | | | | |
| Number of catches of | 0 | 0 | 0 | 0 | 0 | 0 |
| red sea bream of | | | | | | |
| 30 cm or more | | | | | | |
| Ratio of total number of | 23 | 30 | 55 | 59 | 63 | 50 |
| catches to maximum | | | | | | |
| total number of | | | | | | |
| catches (Example 15) (%) | | | | | | |

### <Test (13)>

Horse mackerel fishing was carried out by a fishing method called Ajing at a dock of a fishing port in Karatsu City, Saga Prefecture, on Feb. 7, 2024. Seven anglers as testers conducted the test for 7 hours from 9:00 AMV to 4:00 PM.

Ajing is a fishing method of targeting mainly horse mackerel and various other fish species, in which a rig is sunk, and a Jig head hook is moved by operating a rod.

In the present test (13), the following rig was used.

An ultra-high molecular weight polyethylene line having a diameter of 0.045 mm was used as a main line, a shock leader was tied to the tip of the main line, and a 1 g jig head hook was tied to the tip of the leader. A lure worm made of resin was attached to the jig head hook. A 1 m long fishing line for a test was used as the shock leader. As the fishing line for a test, the fishing lines of Examples 1 to 3 and Comparative Examples 1 to 4 (all of the fishing lines had a diameter of 0.12 mm) were used.

Seven testers performed fishing by changing fishing lines for each test every hour. Specifically, for example, fishing is carried out with a rig using the fishing line of Example 1 as a shock leader until 1 hour from the start, and fishing is carried out with a rig using the fishing line of Example 2 instead of the fishing line of Example 1 during a time period from 1 hour to 2 hours after the start. The locations of the testers were exchanged to each other so that the same tester was not fixed to one place (fishing seat) at the dock.

In Table 19, the catches when the respective fishing lines of Examples and Comparative Examples were used are summarized for each fish species. Note that, in the column of fish species in Table 18, “e” represents Japanese horse mackerel, and “f” represents barracuda.

As is apparent from the table, in the fishing lines of Examples, the ratio of the total number of catches is 70% or more. Therefore, the catches of the fishing lines of Examples are superior to those of the fishing lines of Comparative Examples. In particular, in Examples 1 and 2, not only the number of catches was high, but also a plurality of large horse mackerels of 30 cm or more and barracuda of 40 cm or more were caught. This is considered to be because the light transmitted through the fishing lines of Examples 1 and 2 did not suppress the foraging instinct of large horse mackerel and barracuda.

TABLE 19

| | Example | | Example | | Example | | Comparative | | Comparative | | Comparative | | Comparative | |
|---|---|---|---|---|---|---|---|---|---|---|---|---|---|---|
| | 1 | | 2 | | 3 | | Example 1 | | Example 2 | | Example 3 | | Example 4 | |
| Fish species | e | f | e | f | e | f | e | f | e | f | e | f | e | f |
| Number of catches | 58 | 6 | 65 | 8 | 53 | 5 | 45 | 3 | 46 | 1 | 43 | 0 | 37 | 0 |
| Total number of catches | 64 | | 73 | | 58 | | 48 | | 47 | | 43 | | 37 | |
| Number of catches of | 3 | | 4 | | 3 | | 1 | | 0 | | 0 | | 0 | |
| horse mackerel of | | | | | | | | | | | | | | |
| 30 cm or more | | | | | | | | | | | | | | |
| Number of catches of | 2 | | 3 | | 1 | | 1 | | 0 | | 0 | | 0 | |
| barracuda of 40 cm or more | | | | | | | | | | | | | | |
| Ratio of total number of | 88 | | 100 | | 79 | | 66 | | 64 | | 59 | | 51 | |
| catches to maximum | | | | | | | | | | | | | | |
| total number of | | | | | | | | | | | | | | |
| catches (Example 2) (%) | | | | | | | | | | | | | | |

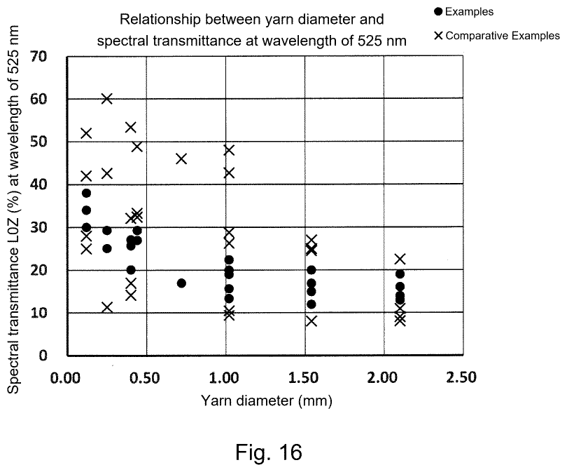

FIG. 16 is a graph plotting the relationship between the yarn diameter (the diameter of the fishing line) and the spectral transmittance L0Z at a wavelength of 525 nm of the fishing line in each of Examples and Comparative Examples. In FIG. 16, for example, three black circles and four cross marks are shown on a yarn diameter of 0.12 mm. Referring to Table 1, the three black circles correspond to Examples 1 to 3, and referring to Table 3, the four cross marks correspond to Comparative Examples 1 to 4. Similarly, corresponding Examples and Comparative Examples are plotted on yarn diameters of 0.25 mm, 0.40 mm, 0.44 mm, 0.72 mm, 1.02 mm, 1.54 mm, and 2.10 mm, respectively. For the numerical values of the yarn diameter and the spectral transmittance, see Tables 1 to 5.

The reason why the present inventors have focused on the spectral transmittance L0Z at a wavelength of 525 nm within the range of a wavelength of 425 nm to 575 nm is that saltwater fish are particularly sensitive to light of 520 nm. The reason why attention is paid to the yarn diameter is that the yarn diameter is empirically recognized as an important factor that affects the catch.

In FIG. 16, the fishing lines of respective Examples represented by black circles are fishing lines in which a good catch can be expected for various fish species from the actual fishing test, and have a spectral transmittance L0Z in a predetermined range for each yarn diameter. The fishing lines of respective Comparative Examples represented by cross marks are fishing lines in which a good catch cannot be expected. As is apparent from FIG. 16, the fishing lines of Examples are concentrated in a predetermined range in the relationship between the spectral transmittance L0Z and the yarn diameter, and the fishing lines of Comparative Examples are out of the above range. The test results reveal that the fishing lines included in the predetermined range in the relationship between the spectral transmittance L0Z and the yarn diameter are fishing lines in which a good catch can be expected.

In order to determine the range of the fishing line in which a good catch can be expected, an approximate curve of each of the upper boundary line and the lower boundary line of Example and Comparative Example was calculated by the least squares method. Specifically, it is as follows.

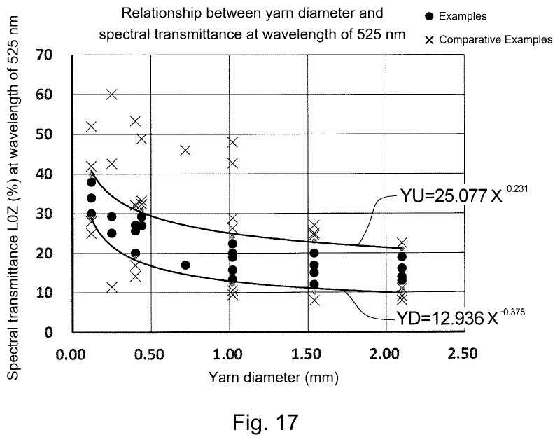

FIG. 17 is a graph obtained by drawing approximate curves, which are boundary lines between Example and Comparative Example, in the graph of FIG. 16.

As shown in FIG. 17, for example, the upper limit of the spectral transmittance of Example at a yarn diameter of 0.12 mm is 38%. This 38% is the spectral transmittance at 525 nm in Example 1 (see Table 1). The spectral transmittance of Comparative Example closest to this upper limit is 42%, and this 42% is the spectral transmittance of Comparative Example 2 (see Table 3). It is considered that the boundary between Example and Comparative Example exists between 38% and 42%, that is, a boundary between a fishing line excellent in catch and a fishing line not excellent in catch exists between 38% and 42%. The lower limit of the spectral transmittance of Example at a yarn diameter of 0.12 mm is 30%. This 30% is the spectral transmittance at 525 nm in Example 3 (see Table 1). The spectral transmittance of Comparative Example closest to this lower limit is 28%, and this 28% is the spectral transmittance of Comparative Example 3 (see Table 3). It is considered that a boundary between a fishing line excellent in catch and a fishing line not excellent in catch exists between 30% and 28%.

Similarly, the spectral transmittance of the upper limit of Example and the spectral transmittance of Comparative Example closest to the upper limit at each of the yarn diameters of 0.40 mm, 0.44 mm, 1.02 mm, 1.54 mm, and 2.10 mm, and the spectral transmittance of the lower limit of Example and the spectral transmittance of Comparative Example closest to the lower limit at each of the yarn diameters were extracted. The extracted spectral transmittances are shown in Table 20. Regarding Examples and Comparative Examples to which these spectral transmittances correspond, see Tables 1 to 5. The lower limit of the yarn diameter of 0.44 mm and the yarn diameter of 0.72 mm is omitted because the number of data is small.

TABLE 20

| | Yarn diameter (mm) | | | | | |
|---|---|---|---|---|---|---|
| | 0.12 | 0.4 | 0.44 | 1.02 | 1.54 | 2.1 |
| (1) Upper limit of spectral transmittance of Example (%) | 38 | 27 | 29 | 22 | 20 | 19 |
| (2) Spectral transmittance of Comparative Example | 42 | 37 | 32 | 26 | 25 | 23 |
| closest to upper limit of Example (%) | | | | | | |
| (3) Calculated data of approximate curve of upper side | 40 | 32 | 31 | 24 | 23 | 21 |
| (average value between (1) and (2)) | | | | | | |
| (4) Lower limit of spectral transmittance of Example (%) | 30 | 20 | — | 13 | 12 | 13 |
| (5) Spectral transmittance of Comparative Example | 28 | 17 | — | 11 | 8 | 8 |
| closest to lower limit of Example (%) | | | | | | |
| (6) Calculated data of approximate curve of lower side | 29 | 19 | — | 12 | 10 | 11 |
| (average value between (4) and (5)) | | | | | | |

As shown in Table 20, the average value of the upper limit of the spectral transmittance of Example and the spectral transmittance of Comparative Example closest to the upper limit was obtained for each yarn diameter. This average value is as shown in the column (3) of Table 20. An approximate curve was calculated by applying the least squares method and performing power approximation using data in which the spectral transmittance YU in the column of (3) is taken as the vertical axis and the yarn diameter X is taken as the horizontal axis (see FIG. 17). As a result, the following Formula (5) was obtained.

YU=25.077X^{-0.231} Formula (5):

Similarly, the average value of the lower limit of the spectral transmittance of Example and the spectral transmittance of Comparative Example closest to the lower limit was obtained for each yarn diameter. This average value is as shown in the column (6) in Table 20. An approximate curve was calculated by applying the least squares method and performing power approximation using data in which the spectral transmittance YD in the column of (6) is taken as the vertical axis and the yarn diameter X is taken as the horizontal axis (see FIG. 17). As a result, the following Formula (6) was obtained.

YD=12.936X^{-0.378} Formula (6):

It can be said that a good catch can be expected in the fishing line in which the spectral transmittance L0Z at a wavelength of 525 nm satisfies 25.1X^{-0.23}<L0Z<12.9X^{-0.38} by rounding off the predetermined decimal places.

### DESCRIPTION OF REFERENCE SIGN

1 Fishing line

1. A method for producing a fishing line by making a forming material containing a colorant and a resin component into yarn, wherein
a spectral transmittance of the fishing line at a wavelength of 425 nm to 575 nm is within a range of 13% to 40%, and
a spectral transmittance L0Z of the fishing line at a wavelength of 525 nm satisfies 25.1X^{-0.23}<L0Z<12.9X^{-0.38} where X represents a diameter (mm) of the fishing line.

2. The method for producing a fishing line according to claim 1, wherein the resin component contains polyvinylidene fluoride.

3. A fishing line comprising a colorant and a resin component, wherein
a spectral transmittance of the fishing line at a wavelength of 425 nm to 575 nm is within a range of 13% to 40%, and
a spectral transmittance L0Z of the fishing line at a wavelength of 525 nm satisfies a relationship of 25.1X^{-0.23}<L0Z<12.9X^{-0.38} where X represents a diameter (mm) of the fishing line.

4. A method for evaluating a fishing line, comprising:
measuring a spectral transmittance and a diameter of a fishing line; and
confirming that a spectral transmittance of the fishing line at a wavelength of 425 nm to 575 nm satisfies 13% to 40%, and a spectral transmittance L0Z of the fishing line at a wavelength of 525 nm satisfies a relationship of 25.1X^{-0.23}<L0Z<12.9X^{-0.38} where X represents a diameter (mm) of the fishing line.
